(19) United States
(12) Patent Application Publication
(10) Pub. No.: US 2024/0413881 A1
(43) Pub. Date: Dec. 12, 2024

(54) QUASI CO-LOCATED SIGNALS OF DIFFERENT RADIO ACCESS TECHNOLOGIES

(71) Applicant: QUALCOMM INCORPORATED, San Diego, CA (US)

(72) Inventors: Weimin DUAN, San Diego, CA (US); Alexandros MANOLAKOS, Athens (GR); Jing LEI, San Diego, CA (US)

(21) Appl. No.: 18/701,840

(22) PCT Filed: Nov. 21, 2022
(86) PCT No.: PCT/US2022/080225

§ 371 Date: Apr. 16, 2024

(30) Foreign Application Priority Data
Dec. 16, 2021 (GR) 20210100889

(51) Int. Cl. H04B 7/06; H04B 17/20

(52) U.S. Cl. CPC H04B 7/06968; H04B 17/254

(57) ABSTRACT

A reference signal measurement method includes: receiving, at a user equipment from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology; receiving, at the user equipment from the transmission/reception point, the first signal and the second signal; and measuring, at the user equipment, the first signal based on the quasi co-location indication indicating that the first signal is quasi co-located with the second signal.

### CROSS-REFERENCE TO RELATED APPLICATIONS

This application claims the benefit of Greek Patent Application Ser. No. 20210100889, filed Dec. 16, 2021, entitled “QUASI CO-LOCATED SIGNALS OF DIFFERENT RADIO ACCESS TECHNOLOGIES,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long-Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example user equipment includes: a transceiver; a memory; and a processor, communicatively coupled to the memory and the transceiver, configured to: receive, via the transceiver from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology; receive, via the transceiver from the transmission/reception point, the first signal and the second signal; and measure the first signal based on the quasi co-location indication indicating that the first signal is quasi co-located with the second signal.

An example reference signal measurement method includes: receiving, at a user equipment from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology; receiving, at the user equipment from the transmission/reception point, the first signal and the second signal; and measuring, at the user equipment, the first signal based on the quasi co-location indication indicating that the first signal is quasi co-located with the second signal.

Another example user equipment includes: means for receiving, from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology; means for receiving, from the transmission/reception point, the first signal and the second signal; and means for measuring the first signal based on the quasi co-location indication indicating that the first signal is quasi co-located with the second signal.

An example non-transitory, processor-readable storage medium includes processor-readable instructions to cause a processor of a user equipment to: receive, from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology; receive, from the transmission/reception point, the first signal and the second signal; and measure the first signal based on the quasi co-location indication indicating that the first signal is quasi co-located with the second signal.

An example network entity includes: a transceiver; a memory; and a processor, communicatively coupled to the memory and the transceiver, configured to: schedule transmission of a first signal, from a transmission/reception point and corresponding to a first radio access technology, and a second signal from the transmission/reception point and corresponding to a second radio access technology that is different from the first radio access technology; and transmit, via the transceiver to a user equipment, a quasi co-location indication that indicates that the first signal is quasi co-located with the second signal.

An example signal transmission scheduling method includes: scheduling, by a network entity, transmission of a first signal, from a transmission/reception point and corresponding to a first radio access technology, and a second signal from the transmission/reception point and corresponding to a second radio access technology that is different from the first radio access technology; and transmitting, from the network entity to a user equipment, a quasi co-location indication that indicates that the first signal is quasi co-located with the second signal.

Another example network entity includes: means for scheduling transmission of a first signal, from a transmission/reception point and corresponding to a first radio access technology, and a second signal from the transmission/reception point and corresponding to a second radio access technology that is different from the first radio access technology; and means for transmitting, to a user equipment, a quasi co-location indication that indicates that the first signal is quasi co-located with the second signal.

Another example non-transitory, processor-readable storage medium includes processor-readable instructions to cause a processor of a network entity to: schedule transmission of a first signal, from a transmission/reception point and corresponding to a first radio access technology, and a second signal from the transmission/reception point and corresponding to a second radio access technology that is different from the first radio access technology; and transmit, to a user equipment, a quasi co-location indication that indicates that the first signal is quasi co-located with the second signal.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example network entity.

FIG. 7 is a simplified diagram of a transmission schedule of an MBSFN DSS (multi-media broadcast over a single frequency network dynamic spectrum sharing) slot.

FIG. 8 is a simplified diagram of a transmission schedule of a non-MBSFN DSS slot.

FIG. 9 is a simplified diagram of a transmission schedule of a slot with a demodulation reference signal and long-term evolution and new radio co-existence.

FIG. 10 is a timing diagram of a new radio sleep and wake-up schedule.

FIG. 11 is a timing diagram of a long-term evolution sleep and wake-up schedule.

FIG. 12 is a simplified diagram of quasi co-located signal transmission and reception.

FIG. 13 is a timing diagram of a signaling and process flow for supplementing positioning using a primary radio access technology with reference signal measurement using a secondary radio access technology, and determining position information.

FIG. 14 is a simplified diagram of a transmission schedule including a primary radio access technology reference signal and a secondary radio access technology reference signal.

FIG. 15 is another simplified diagram of a transmission schedule including a primary radio access technology reference signal and a secondary radio access technology reference signal.

FIG. 16 is another simplified diagram of a transmission schedule including a primary radio access technology reference signal and a secondary radio access technology reference signal.

FIG. 17 is a block flow diagram of a reference signal measurement method.

FIG. 18 is a block flow diagram of a signal transmission scheduling method.

### DETAILED DESCRIPTION

Techniques are discussed herein for transmitting and measuring quasi co-located signals using different radio access technologies (RATs), e.g., for use in determining position of a user equipment (UE). A network entity may transmit quasi co-located (QCLed) signals using different RATs to a UE and indicate to the UE that the signals are QCLed. The UE may measure the QCLed signals, and may leverage the fact that the signals are QCLed, e.g., to use measurement of one signal using one RAT to set a transmit power for another signal using the other RAT. The signal in one RAT may be more dense than the signal in another RAT and the more dense signal may be measured to reduce a wake-up time of the UE, and thus reduce power consumption for signal measurement compared to measuring a less dense signal. These implementations are examples, and other implementations may be used.

Items and/or techniques described herein may provide one or more of the following capabilities, as well as other capabilities not mentioned. Power may be saved, e.g., by measuring a more dense signal rather than a less dense signal (e.g., an always-on channel reference signal versus a positioning reference signal). Positioning accuracy may be improved, e.g., by measuring positioning reference signals in multiple RATs. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

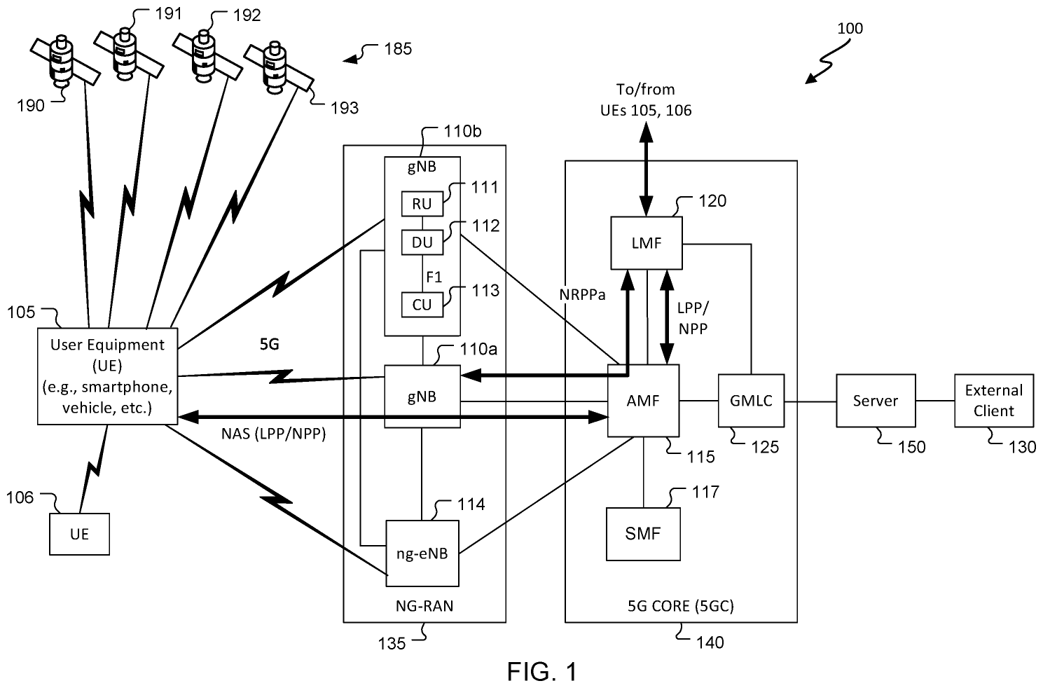

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long-Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long-Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

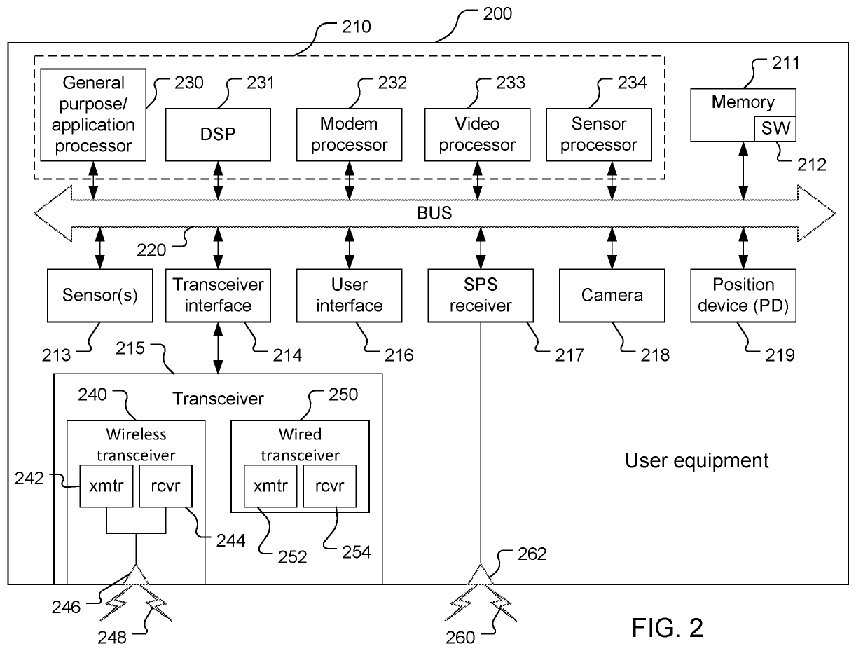

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

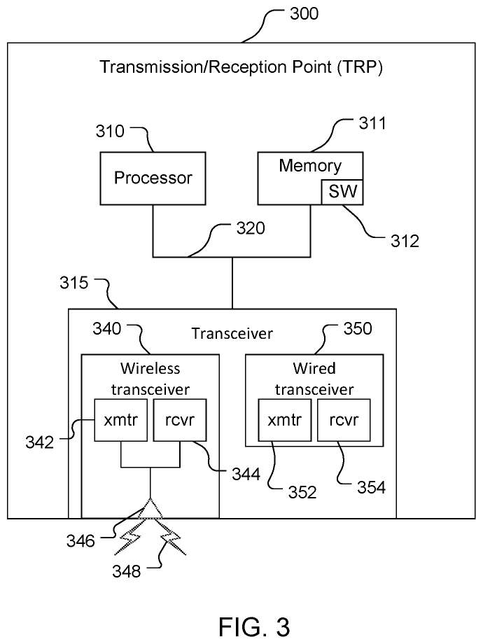

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

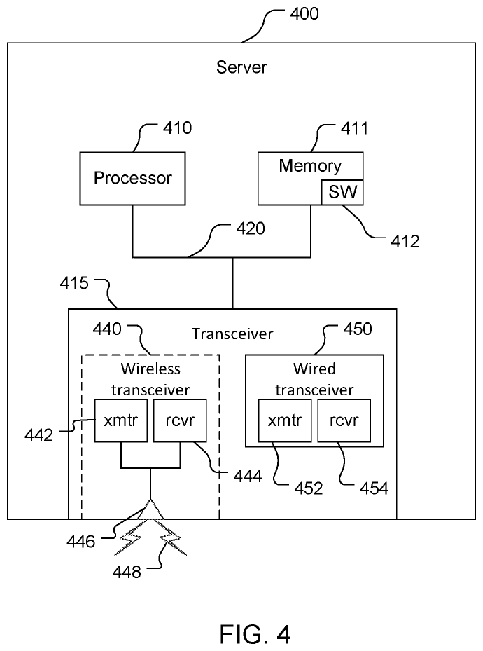

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{RX-TX} or UE_{Rx-TX}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

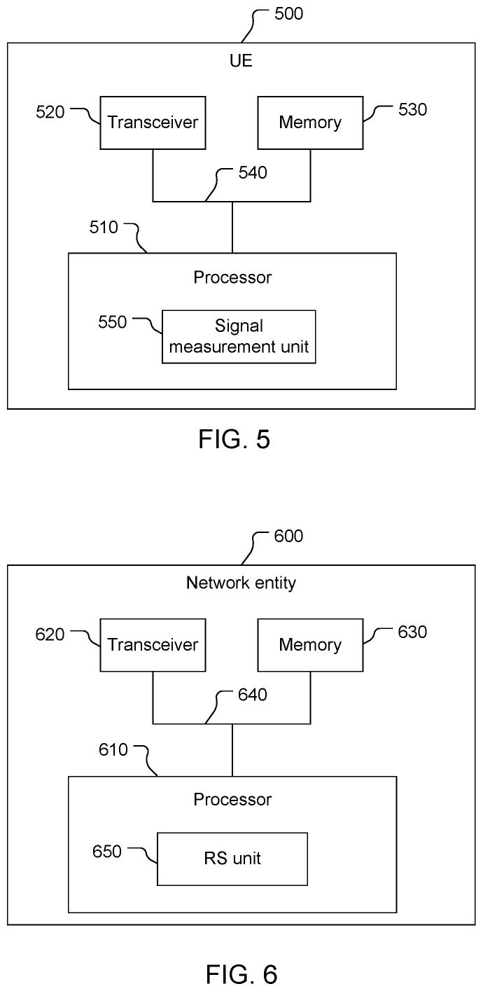

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) includes a signal measurement unit 550. The signal measurement unit 550 is discussed further below, and the description may refer to the processor 510 generally, or the UE 500 generally, as performing any of the functions of the signal measurement unit 550. The UE 500 is configured to perform the functions of the signal measurement unit 550 discussed herein.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) includes an RS unit 650 (reference signal unit). The RS unit 650 is discussed further below, and the description may refer to the processor 610 generally, or the network entity 600 generally, as performing any of the functions of the RS unit 650. The network entity 600 is configured to perform the functions of the RS unit 650 discussed herein.

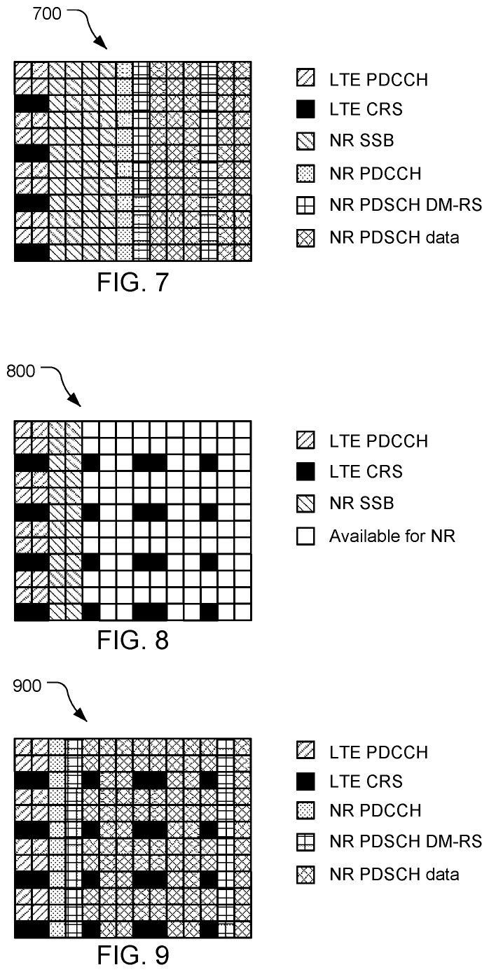

The network entity 600 is configured to transmit, and the UE 500 is configured to receive and measure, signals using multiple different radio access technologies (RATs). For example, the processor 610 and the transceiver 620 may be configured to transmit LTE OFDM signals and NR OFDM signals and the processor 510 and the transceiver 520 may be configured to receive and measure LTE OFDM signals and NR OFDM signals. While the disclosure discusses OFDM signals as examples, the disclosure is applicable to other types of signals. The network entity 600 may be configured to transmit signals of different RATs using different carriers and/or may be configured to transmit signals of different RATs using the same carrier using dynamic spectrum sharing (DSS). For example, as shown in FIGS. 7-9, the network entity 600 may transmit LTE signals and NR signals using DSS. As shown in FIG. 7, the network entity 600 may transmit an NR 15 kHz SSB (Synchronization Signal Block) in an MBSFN (multi-media broadcast over a single frequency network) DSS subframe/slot, here a slot 700 of 12 subcarriers and 14 symbols. As shown in FIG. 8, the network entity 600 may transmit an NR 30 kHz SSB in a non-MBSFN DSS subframe/slot, here a slot 800. As shown in FIG. 9, the network entity 600 may transmit a slot 900 with an NR DM-RS (Demodulation Reference Signal) pattern with LTE/NR coexistence (with resource elements of the different signals interspersed in frequency and time). While signals of different RATs may be transmitted without using DSS, using DSS may save cost (e.g., by using the same site or even the same antenna to transmit the signals, and allowing a service provider to avoid buying a new spectrum license). In the examples shown in FIGS. 7-9, LTE CRS (Channel Reference Signal) (used for synchronization), LTE PDCCH (Physical Downlink Control Channel) (used for scheduling), NR SSB (used for synchronization), NR PDCCH (used for control and scheduling), NR PDSCH (Physical Downlink Shared Channel) DM-RS (used for channel estimation), and NR PDSCH data (used for data transfer) may be transmitted.

The LTE CRS is an always-on signal. The LTE CRS is always transmitted in every slot (every subframe) under all conditions (i.e., there is no condition under which the LTE CRS is not transmitted). Further, the LTE CRS signal is a high-density signal, being transmitted in many subcarriers and in many symbols, facilitating measuring the LTE CRS signal, e.g., allowing an idle mode UE to awake for a short amount of time in order to measure the LTE CRS. The LTE CRS is accessible to both connected mode and idle mode UEs. An idle mode UE may use the CRS for channel estimation, downlink synchronization, RRM (Radio Resource Management) measurement, etc.

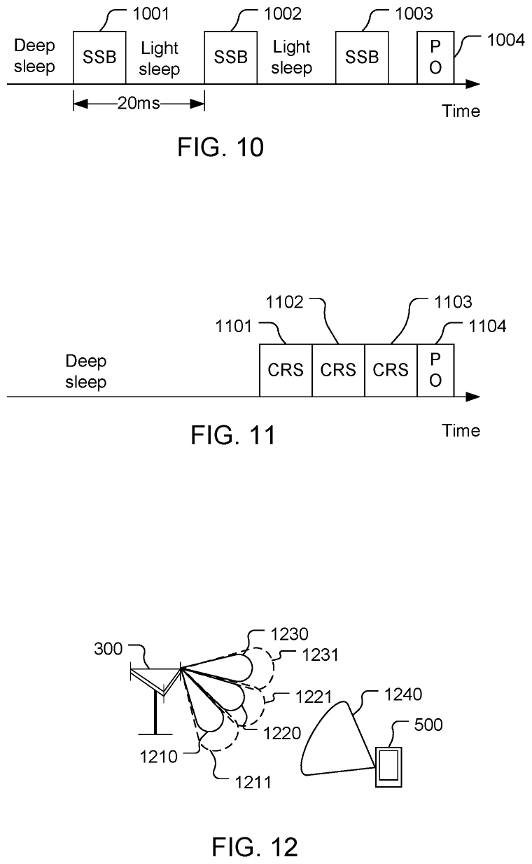

Relative to LTE, NR has fewer resources for UEs in idle/inactive mode and an NR idle/inactive mode UE uses SSB. The SSB signal is transmitted in limited bandwidth with 20 resource blocks and typically with sparse periodicity (e.g., 20 ms). Other reference signals such as CSI-RS (Channel State Information-Reference Signal), TRS (Tracking RS), and PRS may only be available to connected mode UEs on UE-specific configurations (e.g., periodical TRS may be allowed to transmit in the idle mode and inactive mode). Consequently, NR idle/inactive mode operation may use more power than LTE, although an NR network may save power by not transmitting CRS, and may have higher latency (due to longer periodicity of NR SSB than for LTE CRS, e.g., 20 ms vs. 1 ms) and lower accuracy (due to lower bandwidth of NR SSB than LTE CRS). For example, referring also to FIGS. 10 and 11, an NR UE may wake up multiple times to receive multiple SSBs 1001, 1002, 1003 for a tracking loop update and to process a PO 1004 (paging occasion) in a low SNR (signal-to-noise ratio) condition, while an LTE UE may wake up only once to use CRS 1101, 1102, 1103 to update tracking loops and process a PO 1104. If additional RS is(are) available for NR idle/inactive mode UEs, the power saving gain is expected due to the UE being able to wake up and listen for RS for less time than if the RS is transmitted less often.

The UE 500 and the network entity 600 may be configured to support positioning of the UE 500 during RRC idle mode or RRC inactive mode. For RRC-inactive DL, UL, and DL and UL positioning, the UE 500 and the network entity 600 may be configured for PRS transmission/measurement, SRS transmission/measurement, and measurement reporting, respectively, during RRC-inactive mode. For RRC-idle DL positioning, the UE 500 and the network entity 600 may be configured for DL-PRS transmission and measurement, respectively, during RRC-idle mode and measurement reporting during RRC-inactive/connected mode. As discussed herein, LTE CRS may be measured in idle or inactive modes and used for positioning to support RRC idle mode positioning or RRC inactive mode positioning.

Referring to FIG. 12, with further reference to FIGS. 3-6, DL PRS resources may be quasi co-located (QCLed). For DL PRS resources, QCL-TypeC with an SBB from a serving or neighboring TRP is supported, and QCL-TypeD with a DL PRS or SSB from a serving or neighboring TRP is supported. Signals may be considered to be QCLed based on the signals being transmitted by antenna ports that are QCLed. For a QCL relation to be provided between two PRS resources, the PRS resources must be from the same TRP. A QCL relationship may be used to determine a DL PRS beam to measure. For example, the TRP 300 may transmit SSB on beams 1210, 1220, 1230 and the UE 500 may use a receive beam 1240 to measure the SSB on each of the beams 1210, 1220, 1230. The TRP 300 may also indicate beams 1211, 1221, 1231 for DL PRS that are QCLed with the beams 1210, 1220, 1230, respectively. The UE 500, e.g., the signal measurement unit 550, may determine which of the beams 1210, 1220, 1230 yielded the best SSB measurement, and select the corresponding QCLed DL PRS beam 1211, 1221, 1231 for measuring DL PRS. When the UE 500 reports PRS RSRP measurements on PRS resources from one resource set, the UE 500 may indicate which PRS RSRP measurements have been measured using the same receive beam. The UE 500 may provide (through LPP) the time-frequency location for SSB transmission on neighboring TRPs. If the DL PRS has QCL-TypeC and QCL-TypeD with an SSB, then the same SSB index will be indicated.

The UE 500 may be configured for open loop power control. The TRP 300 may send a reference signal (e.g., PRS or SSB or LTE CRS) to the UE 500 and an indication of the transmit power used by the TRP 300 to transmit the reference signal. The UE 500, e.g., the signal measurement unit 550, may measure the reference signal, determine the received power of the reference signal, and determine a path loss between the TRP 300 and the UE 500 as a difference between the transmit power and the receive power of the reference signal. The UE 500 may use the determined path loss plus a minimum receive power for the TRP 300 to set a transmit power for SRS for positioning transmitted by the UE 500 to the TRP 300. The path loss may be determined for a serving TRP and neighboring TRPs. The UE 500 may determine multiple path losses for different SRS resources, e.g., four, eight, or 16 path loss estimates across SRS resource sets.

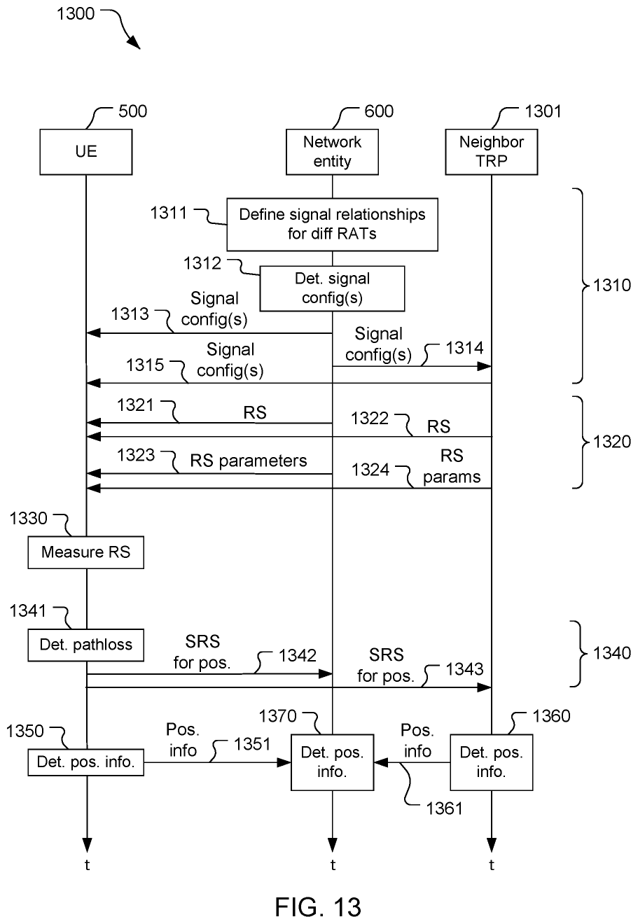

Referring to FIG. 13, with further reference to FIGS. 1-12, a timing diagram shows a signaling and process flow 1300 that includes the stages shown. The flow 1300 is for supplementing positioning using a primary radio access technology (RAT) with reference signal measurement using a secondary RAT, and determining position information based on measured reference signals. The secondary RAT may be, for example, an older RAT than the primary RAT. For example, the primary RAT may be NR and the secondary RAT may be a legacy RAT such as LTE. Thus, for example, LTE CRS measurement may be enabled for NR UE positioning. Flows other than the flow shown are possible, e.g., with one or more stages shown omitted, one or more stages added, and/or one or more shown stages altered. For example, RS of the secondary RAT that is QCLed with an RS of the primary RAT may be transmitted from a serving TRP of the network entity 600 and not from a neighbor TRP 1301, or from the neighbor TRP 1301 and not the network entity 600. As another example, RS parameters such as RS transmit power may not be transmitted from the network entity 600 to the UE 500 and/or from the neighbor TRP 1301 to the UE 500. As other examples, the network entity 600 and/or the neighbor TRP 1301 may not determine position information. Still other alterations of the flow 1300 may be implemented.

At stage 1310, signal relationships and configurations for signals of different RATs are determined and promulgated. At sub-stage 1311, the network entity 600, e.g., the RS unit 650, defines signal relationships between signals of different RATs (e.g., LTE and NR, or NR and a later-developed RAT, or another combination of RATs). The signal relationships may be determined by selecting beams for transmitting RS on the different RATs. The signal relationships may be for signals transmitted on a DSS carrier or different carriers. For example, the network entity 600 may establish that an NR PRS and/or SSB is QCL-Type-C with an LTE CRS from the serving TRP of the network entity and/or that an NR PRS and/or SSB is QCL-Type-C with an LTE CRS from the neighbor TRP 1301. As another example, the network entity 600 may establish that an NR PRS and/or SSB is QCL-Type-D with an LTE CRS from the serving TRP of the network entity 600 and/or that an NR PRS and/or SSB is QCL-Type-D with an LTE CRS from the neighbor TRP 1301. The QCL relationship between the secondary-RAT RS and a DL PRS may be direct (e.g., DL PRS is QCLed with secondary-RAT RS such as LTE CRS) or indirect (e.g., QCL relationship of SSB and secondary-RAT RS is known, and QCL relationship of SSB and DL PRS is known).

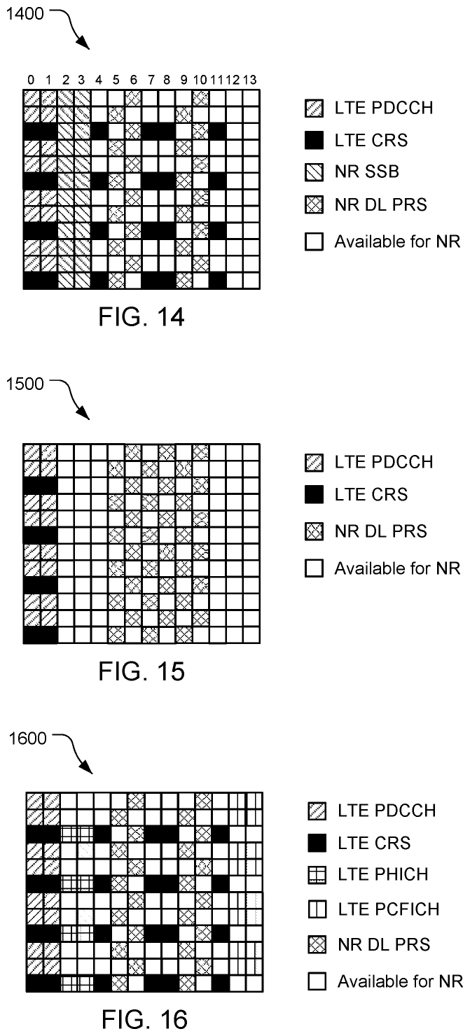

At sub-stage 1312, referring also to FIG. 14, the network entity 600 determines one or more signal configurations for one or more of the QCLed signals. For example, depending on the QCL relationship(s) between a secondary-RAT RS (e.g., LTE CRS) and a primary-RAT RS (e.g., PRS or SSB), possibly on a DSS carrier, the RS unit 650 can determine a transmission pattern 1400 of primary-RAT RS and the secondary-RAT RS for use by the UE 500 (that supports the primary RAT and the secondary RAT). The transmission pattern may be specified in terms of which REs (specified by symbol(s) and subcarrier(s)) carry which signals. In the transmission pattern 1400 shown in FIG. 14, the primary-RAT RS is an NR DL PRS and the secondary-RAT RS is an LTE CRS. The RS unit 650 is configured to transmit signal configuration(s) 1313, 1314 (e.g., the transmission pattern 1400) of the primary-RAT RS and/or the secondary-RAT RS to the UE 500 and/or the neighbor TRP 1301, respectively. The neighbor TRP 1301 can transmit one or more of the signal configuration(s) 1314 as signal configuration(s) 1315 to the UE 500. The signal configurations 1313-1315 may include indications of signal relationships, e.g., which signal(s) is(are) QCLed with which other signal(s) as defined in sub-stage 1311. The indications of the signal configuration(s) 1313, 1315 may facilitate additional intra-frequency and inter-frequency measurements by a UE configured to operate in the primary RAT, e.g., the UE 500, in one or more RRC states (idle, inactive, and/or connected). For example, the RS unit 650 may be configured to indicate the secondary-RAT RS transmission pattern, resource ID, and/or transmit power offset through a positioning SIB (System Information Block) and/or through dedicated RRC signaling. The secondary-RAT RS transmission pattern configured by the network entity 600 for the UE 500 may be a subset of the RS transmitted by the network entity 600 (e.g., an eNB of the network entity 600), with the subset of the RS being QCLed with one or more signals of the primary RAT, e.g., DL PRS and/or SSB. Thus, the transmission pattern for the secondary-RAT RS may include the secondary-RAT RS that is QCLed with a primary-RAT RS and exclude one or more secondary-RAT RS that is/are not QCLed with a respective primary-RAT RS. For example, for LTE dynamic TDD (Time Division Duplex), an eNB transmits CRS in every subframe, and the network entity (e.g., gNB/LMF) may configure the UE 500 to measure a subset of subframes.

The network entity 600 may determine the signal configurations such that the primary-RAT RS and the secondary-RAT RS are not transmitted in the same symbol. For example, the network entity 600 may determine configurations of DL PRS and LTE CRS such that no single symbol contains both an RE for the DL PRS and an RE for the LTE CRS. This may help avoid collisions, e.g., because LTE CRS is dense and PRS have regular comb-number spacing and thus having LTE CRS and DL PRS in the same symbol is likely to result in collisions. In the transmission pattern 1400, for example, the NR DL PRS are transmitted in symbols 5, 6, 9, and 10 while the LTE CRS are transmitted in symbols 0, 1, 4, 7, 8, and 11. The network entity 600 may determine the signal configurations such that a slot (e.g., the slot of the transmission pattern 1400) contains both one or more REs for the primary-RAT RS and one or more REs for the secondary-RAT RS, e.g., such that a single slot contains DL PRS on one or more symbols and LTE CRS on one or more other symbols. The UE 500 may assume that DL PRS is not mapped to symbols containing CRS transmission of a neighbor TRP, e.g., that the network entity 600 will schedule DL PRS so that the DL PRS will not collide with CRS from a neighbor TRP.

Various signal configurations may help enable secondary-RAT RS measurement to help a primary-RAT enabled UE, e.g., the UE 500, with positioning. For example, the network entity 600 (e.g., an LMF) may configure the secondary-RAT RS (e.g., LTE CRS) as a (supplementary) positioning reference signal for primary-RAT positioning with the UE 500 in an RRC idle state or an RRC inactive state. To configure the secondary-RAT RS as a supplementary positioning RS, the network entity 600 sends a request in the signal configuration(s) 1313 for the UE 500 to take one or more positioning measurements (e.g., ToA) of the secondary-RAT RS and to report the measurement(s) to the network entity 600. To help the UE 500 with the measurement(s), the network entity 600 may provide some assistance data (e.g., one or more RS parameters as discussed below with respect to stage 1320). As another example, multi-port secondary-RAT RS may be configured which may enable advanced non-line-of-sight (NLOS) mitigation. For example, the UE 500, e.g., the signal measurement unit 550, may measure multiple times of arrival (ToAs) corresponding to a secondary-RAT RS (e.g. LTE CRS) transmitted from different antenna ports. The UE 500 selects the ToA corresponding to the shortest travel time as the final ToA estimate. If the times of departure of the signals are the same, then the UE 500 selects the earliest ToA from the different antenna ports as the final ToA estimate. Also or alternatively, the UE 500 may report the multiple ToAs, corresponding to the different antenna ports, to the network entity 600 such that the network entity 600 (e.g., an LMF) can determine the final ToA estimation.

Also or alternatively, the signal configurations may be determined to support a DSS-related UE positioning deployment. For example, UE positioning (e.g., NR UE positioning) may be deployed on a DSS carrier in standalone (SA) mode. In the SA mode, a primary-RAT radio (e.g., NR radio) connects directly to a primary-RAT core network, e.g., the 5GC 140, and control signaling is independent of a secondary-RAT network (e.g., a legacy network such as a 4G network). The SA deployment of UE positioning may be supported through the signal configurations in a variety of ways, e.g., for LTE deployments. The network entity 600 configures the deployment by setting the transmission schedule for various purposes (e.g., which REs for DL-PRS and which REs for other purposes (e.g., CRS, PDCCH, etc.) and may request the UE 500 to measure CRS and report the CRS measurement(s). The REs for DL-PRS are chosen to avoid collisions with other signals. For example, referring also to FIG. 15, in an LTE MBSFN subframe, the network entity 600 may configure a transmission schedule 1500 with symbols not occupied by LTE CRS/PDCCH for NR DL-PRS. As another example, referring also to FIG. 16, in an LTE non-MBSFN subframe, the network entity 600 may configure a transmission schedule 1600 with symbols not occupied by LTE CRS/PDCCH/PHICH/PCFICH for NR DL-PRS, where PHICH is a Physical HARQ (hybrid automatic repeat request) Indicator Channel, and PCFICH is a Physical Control Format Indicator Channel.

The network entity 600 may configure secondary-RAT PRS as a complimentary PRS for primary-RAT positioning. For example, LTE PRS could serve as the PRS for NR UE positioning measurement. Similar to the discussion above with CRS as an example RS, the network entity 600 may establish that an NR PRS and/or SSB is QCL-Type-C with an LTE PRS from the serving TRP of the network entity 600 and/or that an NR PRS and/or SSB is QCL-Type-C with an LTE PRS from the neighbor TRP 1301. As another example, the network entity 600 may establish that an NR PRS and/or SSB is QCL-Type-D with an LTE PRS from the serving TRP of the network entity and/or that an NR PRS and/or SSB is QCL-Type-D with an LTE PRS from the neighbor TRP 1301. The QCL relationship between the secondary-RAT RS and a DL PRS may be direct (e.g., DL PRS is QCLed with secondary-RAT RS such as LTE PRS) or indirect (e.g., QCL relationship of SSB and secondary-RAT RS (e.g., LTE PRS) is known, and QCL relationship of SSB and DL PRS is known).

At stage 1320, the network entity 600 and the neighbor TRP 300 transmit RS 1321, 1322 to the UE 500 and transmit RS parameters 1323, 1324 to the UE 500. The RS parameters 1323, 1324 are indications of values of parameters of the RS 1321, 1322. The RS parameters 1323, 1324 provide various information and may be used for various purposes. For example, the RS parameters 1323, 1324 may include indications of QCL relationships of signals. As another example, the network entity 600 and/or the neighbor TRP 1301 may be configured to support configuring a secondary-RAT RS (e.g., LTE CRS, LTE PRS) of a serving and/or a neighbor cell to be used as a DL path loss reference. The RS parameters 1323, 1324 may contain one or more respective indications of transmit power of the secondary-RAT RS (e.g., a CRS-Resource-Power information element or an LTE PRS-Resource-Power information element) used by the network entity 600 and/or the neighbor TRP 1301, respectively. The indication of the transmit power may be direct (i.e., a value of the transmit power) or indirect (e.g., an indication of a power offset between a transmit power of the secondary-RAT RS (e.g., LTE CRS) and a transmit power of a primary-RAT RS (e.g., NR SSB/PRS) that is provided to the UE 500). This may help support open loop power control for SRS for positioning as discussed below with respect to stage 1340.

The RS parameters 1323, 1324 may include one or more values to help the UE 500 remove the ToA estimation alias(es). For example, because CRS is not staggered in the frequency domain, the UE 500 may determine multiple possible times of arrival (aliased correlation peaks in the time domain). The network entity 600 and/or the neighbor TRP 1301 may provide expected-RSTD and expected-RSTD-uncertainty values for respective time differences of arrival for signals from the network entity 600 and the neighbor TRP 1301 relative to one or more reference TRPs. The UE 500 may use the expected-RSTD and expected-RSTD-uncertainty values to remove ToA estimation aliases by removing unreasonable ToAs from contention for the actual ToA.

At stage 1330, the UE 500 measures the RS 1321, 1322 and possibly reports one or more measurement values. For example, the signal measurement unit 550 measures the secondary-RAT RS (e.g., LTE CRS or LTE PRS) and may also measure primary-RAT RS. The signal measurement unit 550 may determine one or more measurements, such as RSTD, ToA, received signal power, etc. The UE 500 may use and/or report one or more of the measurement values as discussed further below.

At stage 1340, the UE 500 may determine one or more path losses and may transmit one or more signals based on the determined path loss(es). For example, at sub-stage 1341, the UE 500 may determine a path loss from the network entity 600 to the UE 500 by subtracting a received power of an RS (e.g., LTE CRS) from the network entity 600 from an indicated transmit power for the RS used by the network entity 600. As another example, the UE 500 may determine a path loss from the neighbor TRP 1301 to the UE 500 by subtracting a received power of an RS from the neighbor TRP 1301 from an indicated transmit power for the RS used by the neighbor TRP 1301. The UE 500 may determine a transmit power for SRS for positioning for the network entity 600 as a sum of the path loss between the network entity 600 and the UE 500 and a minimum (or desired) signal receive power for the network entity 600. The UE 500 may determine a transmit power for SRS for positioning for the neighbor TRP 1301 as a sum of the path loss between the neighbor TRP 1301 and the UE 500 and a minimum (or desired) signal receive power for the neighbor TRP 1301. The UE 500 may transmit SRS for positioning 1342 to the network entity 600 and/or SRS for positioning 1343 to the neighbor TRP 1301 using at least the determined transmit power(s).

At stage 1350, 1360, the UE 500 and/or the neighbor TRP 1301 may determine position information. For example, the UE may determine PRS measurements, and may determine information based on one or more measurements (e.g., one or more ranges to one or more other entities (e.g., the network entity 600, the neighbor TRP 1301, the UE 500, etc.), and/or a position estimate for the UE 500. The UE 500 may transmit position information 1351 (e.g., in a measurement report) to the network entity 600, with the position information 1351 including some or all of the position information determined by the UE 500. The neighbor TRP 1301 may transmit position information 1361 (e.g., in a measurement report) to the network entity 600, with the position information 1361 including some or all of the position information determined by the neighbor TRP 1301.

At stage 1370, the network entity 600 may determine position information. For example, the network entity 600 may use some or all of the position information 1351, 1361 to determine a position estimate for the UE 500.

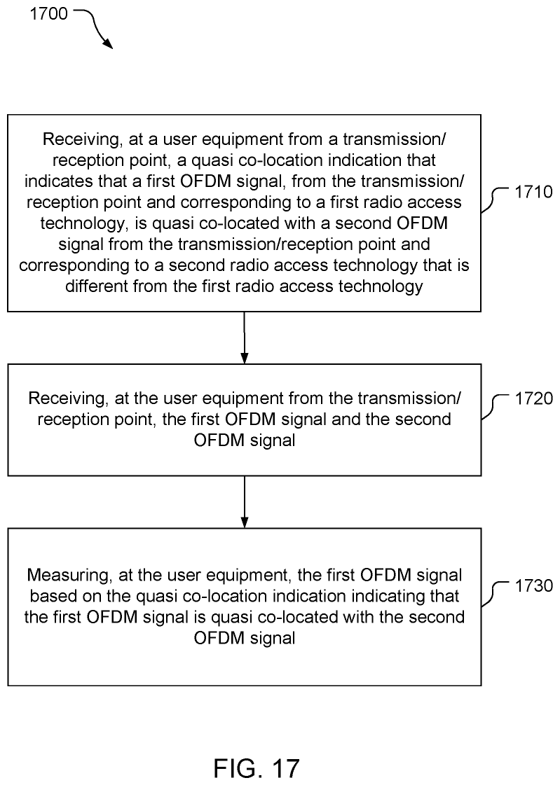

Referring to FIG. 17, with further reference to FIGS. 1-16, a reference signal measurement method 1700 includes the stages shown. The method 1700 is, however, an example only and not limiting. The method 1700 may be altered, e.g., by having stages added, removed, rearranged, combined, performed concurrently, and/or having single stages split into multiple stages.

At stage 1710, the method 1700 includes receiving, at a user equipment from a transmission/reception point, a quasi co-location indication that indicates that a first OFDM signal, from the transmission/reception point and corresponding to a first radio access technology, is quasi co-located with a second OFDM signal from the transmission/reception point and corresponding to a second radio access technology that is different from the first radio access technology. For example, the UE 500 may receive an indication that a primary-RAT signal is QCLed with a secondary-RAT signal in one or more of the signal configurations 1313, 1315 and/or in one or more of the RS parameters 1323, 1324. The processor 510, possibly in combination with the memory 530, possibly in combination with the transceiver 520 (e.g., the wireless receiver 244 and the antenna 246) may comprise means for receiving the quasi co-location indication.

At stage 1720, the method 1700 includes receiving, at the user equipment from the transmission/reception point, the first OFDM signal and the second OFDM signal. For example, the UE 500 may receive the RS 1321 at stage 1320, with the RS 1321 including RS from different RATs, e.g., an LTE RS and an NR RS. The processor 510, possibly in combination with the memory 530, possibly in combination with the transceiver 520 (e.g., the wireless receiver 244 and the antenna 246) may comprise means for receiving the first OFDM signal and the second OFDM signal.

At stage 1730, the method 1700 includes measuring, at the user equipment, the first OFDM signal based on the quasi co-location indication indicating that the first OFDM signal is quasi co-located with the second OFDM signal. For example, at stage 1330, based on knowing that the first OFDM signal is QCLed with the second OFDM signal, the UE 500 measures the received first OFDMN signal, e.g., to determine one or more measurement values (e.g., ToA, RSRP, etc.). In this way, the UE 500 may be able to improve positioning using one RAT by measuring a signal using another RAT. The processor 510, possibly in combination with the memory 530, may comprise means for measuring the first OFDM signal.

Implementations of the method 1700 may include one or more of the following features. In an example implementation, measuring the first OFDM signal is based further on a first periodicity of the first OFDM signal being shorter than a second periodicity of the second OFDM signal. For example, the UE 500, e.g., the signal measurement unit 550, measures the first OFDM signal if the first OFDM signal has a shorter periodicity than the second OFDM signal. In this way, latency may be reduced by measuring a signal that is provided more often. In a further example implementation, measuring the first OFDM signal comprises the user equipment waking up from an idle mode or an inactive mode to measure the first OFDM signal instead of the second OFDM signal based on the first periodicity of the first OFDM signal being shorter than the second periodicity of the second OFDM signal. In this way, power may be conserved and/or latency reduced by measuring a signal that is provided more often so that the UE 500 may wake up from an idle or inactive mode for less time in order to measure the signal, and obtain a signal measurement quicker.

Also or alternatively, implementations of the method 1700 may include one or more of the following features. In an example implementation, measuring the first OFDM signal comprises measuring a receive power of the first OFDM signal, and wherein the reference signal measurement method further comprises: receiving, at the user equipment from the transmission/reception point, an indication of a first transmit power of the first OFDM signal; and transmitting, from the user equipment to the transmission/reception point, an uplink positioning reference signal with a second transmit power based on the receive power of the first OFDM signal and the first transmit power of the first OFDM signal. For example, the UE 500 may receive an indication of RS transmit power from the network entity 600 in the RS parameters 1323, measure a received power of the RS at stage 1330, and at stage 1340 transmit the SRS for positioning 1342 to the network entity with a transmit power based on the measured received power and the indicated transmit power used by the network entity 600. For example, the transmit power of the SRS for positioning 1342 may be the indicated transmit power of the network entity, minus the measured received power at the UE 500, plus at least a minimum receive power of the network entity 600 for measuring the SRS for positioning 1342. This may help ensure that the network entity 600 can accurately measure the SRS for positioning 1342, which may improve accuracy of a determined position estimate for the UE 500. The processor 510, possibly in combination with the memory 530, possibly in combination with the transceiver 520 (e.g., the wireless receiver 244 and the antenna 246) may comprise means for receiving the indication of first transmit power. The processor 510, possibly in combination with the memory 530, possibly in combination with the transceiver 520 (e.g., the wireless transmitter 242 and the antenna 246) may comprise means for transmitting the UL PRS.

Also or alternatively, implementations of the method 1700 may include one or more of the following features. In an example implementation, measuring the first OFDM signal comprises measuring a time of arrival of the first OFDM signal in response to receiving, at the user equipment, a request to measure the time of arrival of the first OFDM signal. For example, the UE 500 (e.g., the signal measurement unit 550) responds to receiving a request in the signal configuration(s) 1313 from the network entity 600 for the UE 500 to measure the ToA of the first OFDM signal (e.g., a secondary-RAT signal such as an LTE CRS). In another example implementation, the first OFDM signal occupies fewer than all subcarriers across a bandwidth of the first OFDM signal, and wherein the reference signal measurement method further comprises: receiving, at the user equipment, indications of an expected reference signal time difference and an expected reference signal time difference uncertainty; and selecting one of a plurality of candidate times of arrival, from measurement of the first OFDM signal, based on the expected reference signal time difference and the expected reference signal time difference uncertainty. For example, a secondary-RAT signal is frequency sampled over a bandwidth, which may result in multiple correlation peaks in the time domain. The UE 500 receives, in the RS parameters 1323, indications of expected RSTD and expected RSTD uncertainty and uses the expected RSTD and expected RSTD uncertainty to select a time of arrival corresponding to one of the multiple correlation peaks as an actual time of arrival. This may help improve positioning accuracy by eliminating one or more ToA estimation aliases from consideration. The UE 500 may report the selected ToA to the network entity 600 for UE-assisted positioning, or use the selected ToA to determine a position estimate of the UE 500 for UE-based positioning. Also or alternatively, the UE 500 may provide the multiple ToAs to the network entity 600 and the network entity 600 may select the actual ToA based on the expected RSTD and the expected RSTD uncertainty. The processor 510, possibly in combination with the memory 530, possibly in combination with the transceiver 520 (e.g., the wireless receiver 244 and the antenna 246) may comprise means for receiving the indications of expected RSTD and expected RSTD uncertainty. The processor 510, possibly in combination with the memory 530, may comprise means for selecting one of the plurality of candidate times of arrival.

Also or alternatively, implementations of the method 1700 may include one or more of the following features. In an example implementation, the second OFDM signal is a synchronization signal block, and measuring the first OFDM signal is based further on a downlink positioning reference signal of the transmission/reception point being quasi co-located with the synchronization signal block. For example, the UE 500, e.g., the signal measurement unit 550, may measure the first OFDM signal (e.g., an LTE CRS) if the second OFDM signal, being an SSB from a TRP, is QCLed with a DL PRS from the TRP. In this way, the UE 500 may measure the first OFDM signal based on (e.g., only if) the second OFDM signal is QCLed with a DL PRS such that measurement of the first OFDM signal is relevant to positioning of the UE. In another example implementation, the first OFDM signal comprises a plurality of first OFDM signals each corresponding to a respective one of a plurality of antenna ports of the transmission/reception point, measuring the first OFDM signal comprises measuring a plurality of times of arrival each corresponding to a respective one of the plurality of first OFDM signals, and the method 1700 further comprises selecting, as an actual time of arrival, which of the plurality of times of arrival corresponds to a shortest travel time from the transmission/reception point to the user equipment. For example, the UE 500 receives a multi-port RS, measures the multi-port RS to determine multiple ToAs corresponding to the multiple ports, and selects, as the actual ToA, the ToA that corresponds to a shortest travel time between a TRP (e.g., of the network entity 600) and the UE 500. The ToA corresponding to the shortest travel time will be the earliest ToA if the times of departures for the different ports are the same. By measuring a multi-port signal and selecting the ToA corresponding to a shortest travel time, measurements of multipath signals may be ignored, thus improving positioning accuracy for the UE 500. The processor 510, possibly in combination with the memory 530, may comprise means for selecting the actual time of arrival from the plurality of times of arrival.

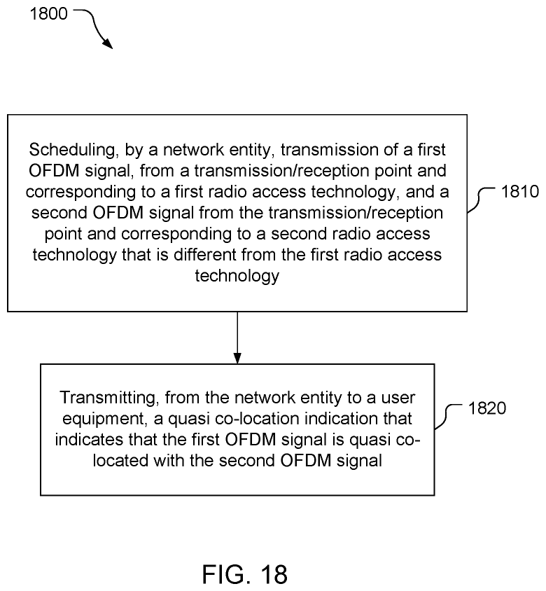

Referring to FIG. 18, with further reference to FIGS. 1-16, a signal transmission scheduling method 1800 includes the stages shown. The method 1800 is, however, an example only and not limiting. The method 1800 may be altered, e.g., by having stages added, removed, rearranged, combined, performed concurrently, and/or having single stages split into multiple stages.

At stage 1810, the method 1800 includes scheduling, by a network entity, transmission of a first OFDM signal (first orthogonal frequency division multiplexing signal), from a transmission/reception point and corresponding to a first radio access technology, and a second OFDM signal from the transmission/reception point and corresponding to a second radio access technology that is different from the first radio access technology. For example, the network entity 600, e.g., the RS unit 650, determines signal transmission patterns for two OFDM signals at sub-stage 1312 and transmits the signal configuration(s) 1313 to the UE 500. The processor 610 (e.g., the processor 310 and/or the processor 410), possibly in combination with the memory 630 (e.g., the memory 311 and/or the memory 411), possibly in combination with the transceiver 620 (e.g., the transceiver 315 and/or the transceiver 415 (e.g., the wireless transmitter 342 and the antenna 346, or the wired transmitter 452 and the wireless transmitter 342 and the antenna 346, or the wireless transmitter 442 and the antenna 446, etc.)) may comprise means for scheduling transmission of the first OFDM signal and the second OFDM signal. Also or alternatively, the neighbor TRP 1301 may schedule transmission of the first and second OFDM signals. The processor 310, in combination with the memory 311, possibly in combination with the transceiver 315 (e.g., the wired transmitter 352 and the wired receiver 354, and/or the wireless transmitter 342, the wireless receiver 344, and the antenna 346) may comprise means for scheduling transmission of the first OFDM signal and the second OFDM signal.

At stage 1820, the method 1800 includes transmitting, from the network entity to a user equipment, a quasi co-location indication that indicates that the first OFDM signal is quasi co-located with the second OFDM signal. For example, the network entity 600 and/or the neighbor TRP 1301 transmits, in the signal configuration(s) 1313, 1315, and/or the RS parameters 1323, 1324, an indication that the first OFDM signal (e.g., a primary-RAT signal) is QCLed with the second OFDM signal (e.g., a secondary-RAT signal). The network entity 600 and/or the neighbor TRP 1301 may thus schedule transmission of signals of different RATs and indicate that the signals are QCLed, which may, for example, help the UE to measure a signal of a secondary RAT to supplement measurement of one or more signals of a primary RAT, which may improve positioning, e.g., improving positioning accuracy, reducing power consumption for positioning, and/or reducing positioning latency, etc. The processor 610 (e.g., the processor 310 and/or the processor 410), possibly in combination with the memory 630 (e.g., the memory 311 and/or the memory 411), in combination with the transceiver 620 (e.g., the transceiver 315 and/or the transceiver 415 (e.g., the wireless transmitter 342 and the antenna 346, or the wireless transmitter 442 and the antenna 446, etc.)) may comprise means for transmitting the quasi co-location indication. Also or alternatively, the processor 310, possibly in combination with the memory 311, in combination with the transceiver 315 (e.g., the wireless transmitter 342 and the antenna 346) may comprise means for transmitting the quasi co-location indication.

Implementations of the method 1800 may include one or more of the following features. In an example implementation, the first OFDM signal is a long-term evolution channel reference signal or a long-term evolution positioning reference signal, and the second OFDM signal is a new radio positioning reference signal or a new radio synchronization signal block. In a further example implementation, the method 1800 further comprises transmitting, from the network entity to the user equipment, a transmit power indication indicating a transmit power of the first OFDM signal by the transmission/reception point. For example, the network entity 600 and/or the neighbor TRP 1301 may transmit and indication of transmit power, used by the network entity 600 or the neighbor TRP 1301, to the UE 500, e.g., as part of the RS parameters 1323, 1324. The UE 500 may use the indication of transmit power to determine a respective transmit power to be used by the UE 500 to transmit one or more signals, e.g., UL PRS (SRS for positioning), to the network entity 600 or the neighbor TRP 1301. This may help ensure the ability of the network entity 600 and/or the neighbor TRP 1301 to measure the signal(s) from the UE 500, which may improve positioning for the UE 500 (e.g., improve accuracy and/or reduce latency). The processor 610 (e.g., the processor 310 and/or the processor 410), possibly in combination with the memory 630 (e.g., the memory 311 and/or the memory 411), in combination with the transceiver 620 (e.g., the transceiver 315 and/or the transceiver 415 (e.g., the wireless transmitter 342 and the antenna 346, or the wireless transmitter 442 and the antenna 446, etc.)) may comprise means for transmitting the transmit power indication. Also or alternatively, the processor 310, possibly in combination with the memory 311, in combination with the transceiver 315 (e.g., the wireless transmitter 342 and the antenna 346) may comprise means for transmitting the transmit power indication.

Also or alternatively, implementations of the method 1800 may include one or more of the following features. In an example implementation, scheduling transmission of the first OFDM signal comprises scheduling a long-term evolution channel reference signal based on the long-term evolution channel reference signal being quasi co-located with the second OFDM signal. For example, the network entity 600 and/or the neighbor TRP 1301 may schedule the second OFDM signal (e.g., a primary-RAT (e.g., NR) PRS or SSB) and schedule an LTE CRS based on the LTE CRS being QCLed with the second OFDM signal. This may help positioning for the UE 500 (e.g., conserve power and/or improve positioning accuracy and/or reduce latency) by scheduling LTE CRS, a signal that has a high density, including a low periodicity, such that the LTE CRS may be measured by the UE 500 quickly, without waking up for a long time from an inactive or idle state. In a further example implementation, the method 1800 further comprises transmitting, from the network entity to the user equipment, a pattern indication indicating an OFDM transmission pattern of the long-term evolution channel reference signal. For example, the network entity 600 and/or the neighbor TRP 1301 transmits an LTE CRS transmission pattern to the UE 500 in the signal configuration(s) 1313, 1315. This may help the UE 500 to measure the LTE CRS, e.g., to determine when to wake up to measure the LTE CRS or when to measure the LTE CRS from a connected state. This may help the UE 500 obtain measurements in addition to primary-RAT signal measurements to improve positioning for the UE 500. The processor 610 (e.g., the processor 310 and/or the processor 410), possibly in combination with the memory 630 (e.g., the memory 311 and/or the memory 411), in combination with the transceiver 620 (e.g., the transceiver 315 and/or the transceiver 415 (e.g., the wireless transmitter 342 and the antenna 346, or the wireless transmitter 442 and the antenna 446, etc.)) may comprise means for transmitting the pattern indication. Also or alternatively, the processor 310, possibly in combination with the memory 311, in combination with the transceiver 315 (e.g., the wireless transmitter 342 and the antenna 346) may comprise means for transmitting the pattern indication. In another further example implementation, the second OFDM signal is a positioning reference signal, and scheduling transmission of the first OFDM signal and the second OFDM signal comprises scheduling transmission of the second OFDM signal in no symbol in which the first OFDM signal is scheduled for transmission. For example, the network entity 600 and/or the neighbor TRP 1301 schedules an LTE CRS and a PRS such that the LTE CRS and the PRS do not share any symbols, which will help avoid collisions and thus help ensure measurement accuracy and accurate positioning.

Also or alternatively, implementations of the method 1800 may include one or more of the following features. In an example implementation, the first OFDM signal is a long-term evolution channel reference signal, and the method 1800 further comprises transmitting, from the network entity to the user equipment, a request for the user equipment to measure the long-term evolution channel reference signal while the user equipment is in a radio resource control inactive mode or a radio resource control idle mode. For example, the network entity 600 and/or the neighbor TRP 1301 may transmit, as part of the signal configuration(s) 1313, 1315, a request for the UE 500 to measure the LTE CRS with the UE 500 with the UE 500 being in an RRC inactive or RRC idle mode. The processor 610 (e.g., the processor 310 and/or the processor 410), possibly in combination with the memory 630 (e.g., the memory 311 and/or the memory 411), in combination with the transceiver 620 (e.g., the transceiver 315 and/or the transceiver 415 (e.g., the wireless transmitter 342 and the antenna 346, or the wireless transmitter 442 and the antenna 446, etc.)) may comprise means for transmitting the request to measure the LTE CRS while the UE is in an RRC inactive mode or an RRC idle mode. Also or alternatively, the processor 310, possibly in combination with the memory 311, in combination with the transceiver 315 (e.g., the wireless transmitter 342 and the antenna 346) may comprise means for transmitting the request to measure the LTE CRS while the UE is in an RRC inactive mode or an RRC idle mode. In another example implementation, the transmission/reception point is a first transmission/reception point, and the method 1800 further comprises transmitting, from the network entity to the user equipment, an expected reference signal time difference between the first OFDM signal and a third OFDM signal corresponding to a second transmission/reception point that is separate from the first transmission/reception point. For example, the network entity 600 and/or the neighbor TRP 1301 transmits an expected RSTD, and may transmit an expected RSTD uncertainty, in the RS parameters 1323, 1324. The UE 500 may use this information to remove one or more ToA estimation aliases, which may improve positioning for the UE 500 (e.g., accuracy). The processor 610 (e.g., the processor 310 and/or the processor 410), possibly in combination with the memory 630 (e.g., the memory 311 and/or the memory 411), in combination with the transceiver 620 (e.g., the transceiver 315 and/or the transceiver 415 (e.g., the wireless transmitter 342 and the antenna 346, or the wireless transmitter 442 and the antenna 446, etc.)) and/or the processor 310, in combination with the memory 311, in combination with the transceiver 315 may comprise means for transmitting the expected RSTD (and the expected RSTD uncertainty). Also or alternatively, the processor 310, possibly in combination with the memory 311, in combination with the transceiver 315 (e.g., the wireless transmitter 342 and the antenna 346) may comprise means for transmitting the expected RSTD (and the expected RSTD uncertainty). In another example implementation, scheduling transmission of the first OFDM signal comprises scheduling a multi-antenna-port channel reference signal, and the method 1800 further comprises transmitting, from the network entity to the user equipment, a request for the user equipment to report a measurement of the first OFDM signal for each antenna port of the multi-antenna-port channel reference signal. For example, the network entity 600 and/or the neighbor TRP 1301 may schedule a multi-port CRS (e.g., LTE CRS) and transmit a request (e.g., in the signal configuration(s) 1313, 1315) to the UE 500 for the UE 500 to report a measurement (e.g., a ToA) for each antenna port of the multi-port CRS. The processor 610 (e.g., the processor 310 and/or the processor 410), possibly in combination with the memory 630 (e.g., the memory 311 and/or the memory 411), in combination with the transceiver 620 (e.g., the transceiver 315 and/or the transceiver 415 (e.g., the wireless transmitter 342 and the antenna 346, or the wireless transmitter 442 and the antenna 446, etc.)) may comprise means for transmitting the request for the UE to report measurement of the first OFDM signal for each of multiple antenna ports. Also or alternatively, the processor 310, possibly in combination with the memory 311, in combination with the transceiver 315 (e.g., the wireless transmitter 342 and the antenna 346) may comprise means for transmitting the request for the UE to report measurement of the first OFDM signal for each of multiple antenna ports.

Also or alternatively, implementations of the method 1800 may include one or more of the following features. In an example implementation, scheduling transmission of the first OFDM signal and the second OFDM signal comprises scheduling the first OFDM signal and the second OFDM signal with a shared spectrum. For example, the first and second OFDM signals may be a primary-RAT signal and a secondary-RAT signal with a DSS deployment, sharing the same carrier. In a further example implementation, scheduling transmission of the first OFDM signal and the second OFDM signal comprises scheduling, for the user equipment in standalone mode, a downlink positioning reference signal in no symbols in which a channel reference signal or physical downlink control channel is scheduled in an MBSFN subframe. In a further example implementation, scheduling transmission of the first OFDM signal and the second OFDM signal comprises scheduling, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN subframe. Scheduling transmission of the first and second OFDM signals in such ways helps avoid collisions, and thus improve measurement accuracy and positioning accuracy for the UE 500.

Also or alternatively, implementations of the method 1800 may include one or more of the following features. In an example implementation, scheduling transmission of the first OFDM signal comprises scheduling a long-term evolution positioning reference signal. In a further example implementation, scheduling transmission of the first OFDM signal comprises scheduling the long-term evolution positioning reference signal instead of a new radio positioning reference signal. In this way, an LTE PRS may be used for positioning without measuring (at least a particular) NR PRS, providing for positioning while saving power and possibly improving positioning accuracy, e.g., by avoiding measuring an NR PRS (e.g., an NR PRS that would decrease positioning accuracy).

### Implementation Examples

Implementation examples are provided in the following numbered clauses.

Clause 1. A user equipment comprising:
a transceiver;
a memory; and
a processor, communicatively coupled to the memory and the transceiver, configured to:
   receive, via the transceiver from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
   receive, via the transceiver from the transmission/reception point, the first signal and the second signal; and
   measure the first signal based on the quasi co-location indication indicating that the first signal is quasi co-located with the second signal.

Clause 2. The user equipment of clause 1, wherein the processor is configured to measure the first signal based further on a first periodicity of the first signal being shorter than a second periodicity of the second signal.

Clause 3. The user equipment of clause 2, wherein the processor is configured to wake up from an idle mode or an inactive mode to measure the first signal instead of the second signal based on the first periodicity of the first signal being shorter than the second periodicity of the second signal.

Clause 4. The user equipment of clause 1, wherein to measure the first signal the processor is configured to measure a receive power of the first signal, and wherein the processor is further configured to:
receive an indication of a first transmit power of the first signal; and
transmit, via the transceiver, an uplink positioning reference signal with a second transmit power based on the receive power of the first signal and the first transmit power of the first signal.

Clause 5. The user equipment of clause 1, wherein to measure the first signal the processor is configured to measure a time of arrival of the first signal in response to receiving, via the transceiver, a request to measure the time of arrival of the first signal.

Clause 6. The user equipment of clause 1, wherein the first signal occupies fewer than all subcarriers across a bandwidth of the first signal, and wherein the processor is further configured to:
receive indications of an expected reference signal time difference and an expected reference signal time difference uncertainty; and
select one of a plurality of candidate times of arrival, from measurement of the first signal, based on the expected reference signal time difference and the expected reference signal time difference uncertainty.

Clause 7. The user equipment of clause 1, wherein the second signal is a synchronization signal block, and wherein the processor is configured to measure the first signal based further on a downlink positioning reference signal of the transmission/reception point being quasi co-located with the synchronization signal block.

Clause 8. The user equipment of clause 1, wherein the first signal comprises a plurality of first signals each corresponding to a respective one of a plurality of antenna ports of the transmission/reception point, and wherein to measure the first signal the processor is configured to measure a plurality of times of arrival each corresponding to a respective one of the plurality of first signals, and wherein the processor is further configured to select, as an actual time of arrival, which of the plurality of times of arrival corresponds to a shortest travel time from the transmission/reception point to the user equipment.

Clause 9. The user equipment of clause 1, wherein the first signal is a first OFDM signal (first orthogonal frequency division multiplexing signal) and the second signal is a second OFDM signal.

Clause 10. A reference signal measurement method comprising:
receiving, at a user equipment from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
receiving, at the user equipment from the transmission/reception point, the first signal and the second signal; and
measuring, at the user equipment, the first signal based on the quasi co-location indication indicating that the first signal is quasi co-located with the second signal.

Clause 11. The reference signal measurement method of clause 10, wherein measuring the first signal is based further on a first periodicity of the first signal being shorter than a second periodicity of the second signal.

Clause 12. The reference signal measurement method of clause 11, wherein measuring the first signal comprises the user equipment waking up from an idle mode or an inactive mode to measure the first signal instead of the second signal based on the first periodicity of the first signal being shorter than the second periodicity of the second signal.

Clause 13. The reference signal measurement method of clause 10, wherein measuring the first signal comprises measuring a receive power of the first signal, and wherein the reference signal measurement method further comprises:
receiving, at the user equipment from the transmission/reception point, an indication of a first transmit power of the first signal; and
transmitting, from the user equipment to the transmission/reception point, an uplink positioning reference signal with a second transmit power based on the receive power of the first signal and the first transmit power of the first signal.

Clause 14. The reference signal measurement method of clause 10, wherein measuring the first signal comprises measuring a time of arrival of the first signal in response to receiving, at the user equipment, a request to measure the time of arrival of the first signal.

Clause 15. The reference signal measurement method of clause 10, wherein the first signal occupies fewer than all subcarriers across a bandwidth of the first signal, and wherein the reference signal measurement method further comprises:
receiving, at the user equipment, indications of an expected reference signal time difference and an expected reference signal time difference uncertainty; and
selecting one of a plurality of candidate times of arrival, from measurement of the first signal, based on the expected reference signal time difference and the expected reference signal time difference uncertainty.

Clause 16. The reference signal measurement method of clause 10, wherein the second signal is a synchronization signal block, and wherein measuring the first signal is based further on a downlink positioning reference signal of the transmission/reception point being quasi co-located with the synchronization signal block.

Clause 17. The reference signal measurement method of clause 10, wherein the first signal comprises a plurality of first signals each corresponding to a respective one of a plurality of antenna ports of the transmission/reception point, and wherein measuring the first signal comprises measuring a plurality of times of arrival each corresponding to a respective one of the plurality of first signals, and wherein the reference signal measurement method further comprises selecting, as an actual time of arrival, which of the plurality of times of arrival corresponds to a shortest travel time from the transmission/reception point to the user equipment.

Clause 18. The reference signal measurement method of clause 10, wherein the first signal is a first OFDM signal (first orthogonal frequency division multiplexing signal) and the second signal is a second OFDM signal.

Clause 19. A user equipment comprising:
means for receiving, from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
means for receiving, from the transmission/reception point, the first signal and the second signal; and
means for measuring the first signal based on the quasi co-location indication indicating that the first signal is quasi co-located with the second signal.

Clause 20. The user equipment of clause 19, wherein the means for measuring the first signal comprise means for measuring the first signal based further on a first periodicity of the first signal being shorter than a second periodicity of the second signal.

Clause 21. The user equipment of clause 20, wherein the means for measuring the first signal comprise means for waking up the user equipment from an idle mode or an inactive mode to measure the first signal instead of the second signal based on the first periodicity of the first signal being shorter than the second periodicity of the second signal.

Clause 22. The user equipment of clause 19, wherein the means for measuring the first signal comprise means for measuring a receive power of the first signal, and wherein the user equipment further comprises:
means for receiving, from the transmission/reception point, an indication of a first transmit power of the first signal; and
means for transmitting, to the transmission/reception point, an uplink positioning reference signal with a second transmit power based on the receive power of the first signal and the first transmit power of the first signal.

Clause 23. The user equipment of clause 19, wherein the means for measuring the first signal comprise means for measuring a time of arrival of the first signal in response to receiving, at the user equipment, a request to measure the time of arrival of the first signal.

Clause 24. The user equipment of clause 19, wherein the first signal occupies fewer than all subcarriers across a bandwidth of the first signal, and wherein the user equipment further comprises:
means for receiving indications of an expected reference signal time difference and an expected reference signal time difference uncertainty; and
means for selecting one of a plurality of candidate times of arrival, from measurement of the first signal, based on the expected reference signal time difference and the expected reference signal time difference uncertainty.

Clause 25. The user equipment of clause 9, wherein the second signal is a synchronization signal block, and wherein the means for measuring the first signal comprise means for measuring the first signal based further on a downlink positioning reference signal of the transmission/reception point being quasi co-located with the synchronization signal block.

Clause 26. The user equipment of clause 19, wherein the first signal comprises a plurality of first signals each corresponding to a respective one of a plurality of antenna ports of the transmission/reception point, and wherein the means for measuring the first signal comprise means for measuring a plurality of times of arrival each corresponding to a respective one of the plurality of first signals, and wherein the user equipment further comprises means for selecting, as an actual time of arrival, which of the plurality of times of arrival corresponds to a shortest travel time from the transmission/reception point to the user equipment.

Clause 27. A non-transitory, processor-readable storage medium comprising processor-readable instructions to cause a processor of a user equipment to:
receive, from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
receive, from the transmission/reception point, the first signal and the second signal; and
measure the first signal based on the quasi co-location indication indicating that the first signal is quasi co-located with the second signal.

Clause 28. The non-transitory, processor-readable storage medium of clause 27, wherein the processor-readable instructions to cause the processor to measure the first signal comprise processor-readable instructions to cause the processor to measure the first signal based further on a first periodicity of the first signal being shorter than a second periodicity of the second signal.

Clause 29. The non-transitory, processor-readable storage medium of clause 28, wherein the processor-readable instructions to cause the processor to measure the first signal comprise processor-readable instructions to cause the processor to wake up the user equipment from an idle mode or an inactive mode to measure the first signal instead of the second signal based on the first periodicity of the first signal being shorter than the second periodicity of the second signal.

Clause 30. The non-transitory, processor-readable storage medium of clause 27, wherein the processor-readable instructions to cause the processor to measure the first signal comprise processor-readable instructions to cause the processor to measure a receive power of the first signal, and wherein the non-transitory, processor-readable storage medium further comprises processor-readable instructions to cause the processor to:
receive, from the transmission/reception point, an indication of a first transmit power of the first signal; and
transmit, to the transmission/reception point, an uplink positioning reference signal with a second transmit power based on the receive power of the first signal and the first transmit power of the first signal.

Clause 31. The non-transitory, processor-readable storage medium of clause 27, wherein the processor-readable instructions to cause the processor to measure the first signal comprise processor-readable instructions to cause the processor to measure a time of arrival of the first signal in response to receiving, at the user equipment, a request to measure the time of arrival of the first signal.

Clause 32. The non-transitory, processor-readable storage medium of clause 27, wherein the first signal occupies fewer than all subcarriers across a bandwidth of the first signal, and wherein the non-transitory, processor-readable storage medium further comprises processor-readable instructions to cause the processor to:
receive indications of an expected reference signal time difference and an expected reference signal time difference uncertainty; and
select one of a plurality of candidate times of arrival, from measurement of the first signal, based on the expected reference signal time difference and the expected reference signal time difference uncertainty.

Clause 33. The non-transitory, processor-readable storage medium of clause 27, wherein the second signal is a synchronization signal block, and wherein the processor-readable instructions to cause the processor to measure the first signal comprise processor-readable instructions to cause the processor to measure the first signal based further on a downlink positioning reference signal of the transmission/reception point being quasi co-located with the synchronization signal block.

Clause 34. The non-transitory, processor-readable storage medium of clause 27, wherein the first signal comprises a plurality of first signals each corresponding to a respective one of a plurality of antenna ports of the transmission/reception point, and wherein the processor-readable instructions to cause the processor to measure the first signal comprise processor-readable instructions to cause the processor to measure a plurality of times of arrival each corresponding to a respective one of the plurality of first signals, and wherein the non-transitory, processor-readable storage medium further comprises processor-readable instructions to cause the processor to select, as an actual time of arrival, which of the plurality of times of arrival corresponds to a shortest travel time from the transmission/reception point to the user equipment.

Clause 35. A network entity comprising:
a transceiver;
a memory; and
a processor, communicatively coupled to the memory and the transceiver, configured to:
   schedule transmission of a first signal, from a transmission/reception point and corresponding to a first radio access technology, and a second signal from the transmission/reception point and corresponding to a second radio access technology that is different from the first radio access technology; and
   transmit, via the transceiver to a user equipment, a quasi co-location indication that indicates that the first signal is quasi co-located with the second signal.

Clause 36. The network entity of clause 35, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

Clause 37. The network entity of clause 36, wherein the processor is further configured to transmit, via the transceiver to the user equipment, a transmit power indication indicating a transmit power of the first OFDM signal by the transmission/reception point.

Clause 38. The network entity of clause 35, wherein to schedule transmission of the first signal, the processor is configured to schedule a channel reference signal based on the channel reference signal being quasi co-located with the second signal.

Clause 39. The network entity of clause 38, wherein the processor is further configured to transmit, via the transceiver to the user equipment, a pattern indication indicating a transmission pattern of the channel reference signal.

Clause 40. The network entity of clause 38, wherein the second signal is a positioning reference signal, and wherein to schedule transmission of the first signal and the second signal, the processor is configured to schedule transmission of the second signal in no symbol in which the first signal is scheduled for transmission.

Clause 41. The network entity of clause 35, wherein the first signal is a channel reference signal, and wherein the processor is further configured to transmit, via the transceiver to the user equipment, a request for the user equipment to measure the channel reference signal while the user equipment is in a radio resource control inactive mode or a radio resource control idle mode.

Clause 42. The network entity of clause 35, wherein the transmission/reception point is a first transmission/reception point, and wherein the processor is further configured to transmit, via the transceiver to the user equipment, an expected reference signal time difference between the first signal and a third signal corresponding to a second transmission/reception point that is separate from the first transmission/reception point.

Clause 43. The network entity of clause 35, wherein to schedule transmission of the first signal, the processor is configured to schedule a multi-antenna-port channel reference signal, and wherein the processor is further configured to transmit, via the transceiver to the user equipment, a request for the user equipment to report a measurement of the first signal for each antenna port of the multi-antenna-port channel reference signal.

Clause 44. The network entity of clause 35, wherein to schedule transmission of the first signal and the second signal, the processor is configured to schedule the first signal and the second signal with a shared spectrum.

Clause 45. The network entity of clause 44, wherein to schedule transmission of the first signal and the second signal, the processor is configured to schedule, for the user equipment in standalone mode, a downlink positioning reference signal in no symbols in which a channel reference signal or physical downlink control channel is scheduled in an MBSFN (multi-media broadcast over a single frequency network) subframe.

Clause 46. The network entity of clause 44, wherein to schedule transmission of the first signal and the second signal, the processor is configured to schedule, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

Clause 47. The network entity of clause 35, wherein to schedule transmission of the first signal, the processor is configured to schedule a long-term evolution positioning reference signal.

Clause 48. The network entity of clause 47, wherein to schedule transmission of the first signal, the processor is configured to schedule the long-term evolution positioning reference signal instead of a new radio positioning reference signal.

Clause 49. A signal transmission scheduling method comprising:
scheduling, by a network entity, transmission of a first signal, from a transmission/reception point and corresponding to a first radio access technology, and a second signal from the transmission/reception point and corresponding to a second radio access technology that is different from the first radio access technology; and
transmitting, from the network entity to a user equipment, a quasi co-location indication that indicates that the first signal is quasi co-located with the second signal.

Clause 50. The signal transmission scheduling method of clause 49, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

Clause 51. The signal transmission scheduling method of clause 50, further comprising transmitting, from the network entity to the user equipment, a transmit power indication indicating a transmit power of the first OFDM signal by the transmission/reception point.

Clause 52. The signal transmission scheduling method of clause 49, wherein scheduling transmission of the first signal comprises scheduling a channel reference signal based on the channel reference signal being quasi co-located with the second signal.

Clause 53. The signal transmission scheduling method of clause 52, further comprising transmitting, from the network entity to the user equipment, a pattern indication indicating an transmission pattern of the channel reference signal.

Clause 54. The signal transmission scheduling method of clause 52, wherein the second signal is a positioning reference signal, and wherein scheduling transmission of the first signal and the second signal comprises scheduling transmission of the second signal in no symbol in which the first signal is scheduled for transmission.

Clause 55. The signal transmission scheduling method of clause 49, wherein the first signal is a channel reference signal, and wherein the signal transmission scheduling method further comprises transmitting, from the network entity to the user equipment, a request for the user equipment to measure the channel reference signal while the user equipment is in a radio resource control inactive mode or a radio resource control idle mode.

Clause 56. The signal transmission scheduling method of clause 49, wherein the transmission/reception point is a first transmission/reception point, and wherein the signal transmission scheduling method further comprises transmitting, from the network entity to the user equipment, an expected reference signal time difference between the first signal and a third signal corresponding to a second transmission/reception point that is separate from the first transmission/reception point.

Clause 57. The signal transmission scheduling method of clause 49, wherein scheduling transmission of the first signal comprises scheduling a multi-antenna-port channel reference signal, and wherein the signal transmission scheduling method further comprises transmitting, from the network entity to the user equipment, a request for the user equipment to report a measurement of the first signal for each antenna port of the multi-antenna-port channel reference signal.

Clause 58. The signal transmission scheduling method of clause 49, wherein scheduling transmission of the first signal and the second signal comprises scheduling the first signal and the second signal with a shared spectrum.

Clause 59. The signal transmission scheduling method of clause 58, wherein scheduling transmission of the first signal and the second signal comprises scheduling, for the user equipment in standalone mode, a downlink positioning reference signal in no symbols in which a channel reference signal or physical downlink control channel is scheduled in an MBSFN (multi-media broadcast over a single frequency network) subframe.

Clause 60. The signal transmission scheduling method of clause 58, wherein scheduling transmission of the first signal and the second signal comprises scheduling, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

Clause 61. The signal transmission scheduling method of clause 49, wherein scheduling transmission of the first signal comprises scheduling a long-term evolution positioning reference signal.

Clause 62. The signal transmission scheduling method of clause 61, wherein scheduling transmission of the first signal comprises scheduling the long-term evolution positioning reference signal instead of a new radio positioning reference signal.

Clause 63. A network entity comprising:
means for scheduling transmission of a first signal, from a transmission/reception point and corresponding to a first radio access technology, and a second signal from the transmission/reception point and corresponding to a second radio access technology that is different from the first radio access technology; and
means for transmitting, to a user equipment, a quasi co-location indication that indicates that the first signal is quasi co-located with the second signal.

Clause 64. The network entity of clause 63, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

Clause 65. The network entity of clause 64, further comprising means for transmitting, to the user equipment, a transmit power indication indicating a transmit power of the first OFDM signal by the transmission/reception point.

Clause 66. The network entity of clause 63, wherein the means for scheduling transmission of the first signal comprise means for scheduling a channel reference signal based on the channel reference signal being quasi co-located with the second signal.

Clause 67. The network entity of clause 66, further comprising means for transmitting, to the user equipment, a pattern indication indicating a transmission pattern of the channel reference signal.

Clause 68. The network entity of clause 66, wherein the second signal is a positioning reference signal, and wherein the means for scheduling transmission of the first signal and the second signal comprise means for scheduling transmission of the second signal in no symbol in which the first signal is scheduled for transmission.

Clause 69. The network entity of clause 63, wherein the first signal is a channel reference signal, and wherein the network entity further comprises means for transmitting, to the user equipment, a request for the user equipment to measure the channel reference signal while the user equipment is in a radio resource control inactive mode or a radio resource control idle mode.

Clause 70. The network entity of clause 63, wherein the transmission/reception point is a first transmission/reception point, and wherein the network entity further comprises means for transmitting, to the user equipment, an expected reference signal time difference between the first signal and a third signal corresponding to a second transmission/reception point that is separate from the first transmission/reception point.

Clause 71. The network entity of clause 63, wherein the means for scheduling transmission of the first signal comprise means for scheduling a multi-antenna-port channel reference signal, and wherein the network entity further comprises means for transmitting, to the user equipment, a request for the user equipment to report a measurement of the first signal for each antenna port of the multi-antenna-port channel reference signal.

Clause 72. The network entity of clause 63, wherein the means for scheduling transmission of the first signal and the second signal comprise means for scheduling the first signal and the second signal with a shared spectrum.

Clause 73. The network entity of clause 72, wherein the means for scheduling transmission of the first signal and the second signal comprise means for scheduling, for the user equipment in standalone mode, a downlink positioning reference signal in no symbols in which a channel reference signal or physical downlink control channel is scheduled in an MBSFN (multi-media broadcast over a single frequency network) subframe.

Clause 74. The network entity of clause 72, wherein the means for scheduling transmission of the first signal and the second signal comprise means for scheduling, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

Clause 75. The network entity of clause 63, wherein the means for scheduling transmission of the first signal comprise means for scheduling a long-term evolution positioning reference signal.

Clause 76. The network entity of clause 75, wherein the means for scheduling transmission of the first signal comprise means for scheduling the long-term evolution positioning reference signal instead of a new radio positioning reference signal.

Clause 77. A non-transitory, processor-readable storage medium comprising processor-readable instructions to cause a processor of a network entity to:
schedule transmission of a first signal, from a transmission/reception point and corresponding to a first radio access technology, and a second signal from the transmission/reception point and corresponding to a second radio access technology that is different from the first radio access technology; and
transmit, to a user equipment, a quasi co-location indication that indicates that the first signal is quasi co-located with the second signal.

Clause 78. The non-transitory, processor-readable storage medium of clause 77, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

Clause 79. The non-transitory, processor-readable storage medium of clause 78, further comprising processor-readable instructions to cause the processor to transmit, to the user equipment, a transmit power indication indicating a transmit power of the first OFDM signal by the transmission/reception point.

Clause 80. The non-transitory, processor-readable storage medium of clause 77, wherein the processor-readable instructions to cause the processor to schedule transmission of the first signal comprise processor-readable instructions to cause the processor to schedule a channel reference signal based on the channel reference signal being quasi co-located with the second signal.

Clause 81. The non-transitory, processor-readable storage medium of clause 80, further comprising processor-readable instructions to cause the processor to transmit, to the user equipment, a pattern indication indicating an transmission pattern of the channel reference signal.

Clause 82. The non-transitory, processor-readable storage medium of clause 80, wherein the second signal is a positioning reference signal, and wherein the processor-readable instructions to cause the processor to schedule transmission of the first signal and the second signal comprise processor-readable instructions to cause the processor to schedule transmission of the second signal in no symbol in which the first signal is scheduled for transmission.

Clause 83. The non-transitory, processor-readable storage medium of clause 77, wherein the first signal is a channel reference signal, and wherein the non-transitory, processor-readable storage medium further comprises processor-readable instructions to cause the processor to transmit, to the user equipment, a request for the user equipment to measure the channel reference signal while the user equipment is in a radio resource control inactive mode or a radio resource control idle mode.

Clause 84. The non-transitory, processor-readable storage medium of clause 77, wherein the transmission/reception point is a first transmission/reception point, and wherein the non-transitory, processor-readable storage medium further comprises processor-readable instructions to cause the processor to transmit, to the user equipment, an expected reference signal time difference between the first signal and a third signal corresponding to a second transmission/reception point that is separate from the first transmission/reception point.

Clause 85. The non-transitory, processor-readable storage medium of clause 77, wherein the processor-readable instructions to cause the processor to schedule transmission of the first signal comprise processor-readable instructions to cause the processor to schedule a multi-antenna-port channel reference signal, and wherein the non-transitory, processor-readable storage medium further comprises processor-readable instructions to cause the processor to transmit, to the user equipment, a request for the user equipment to report a measurement of the first signal for each antenna port of the multi-antenna-port channel reference signal.

Clause 86. The non-transitory, processor-readable storage medium of clause 77, wherein the processor-readable instructions to cause the processor to schedule transmission of the first signal and the second signal comprise processor-readable instructions to cause the processor to schedule the first signal and the second signal with a shared spectrum.

Clause 87. The non-transitory, processor-readable storage medium of clause 86, wherein the processor-readable instructions to cause the processor to schedule transmission of the first signal and the second signal comprise processor-readable instructions to cause the processor to schedule, for the user equipment in standalone mode, a downlink positioning reference signal in no symbols in which a channel reference signal or physical downlink control channel is scheduled in an MBSFN (multi-media broadcast over a single frequency network) subframe.

Clause 88. The non-transitory, processor-readable storage medium of clause 86, wherein the processor-readable instructions to cause the processor to schedule transmission of the first signal and the second signal comprise processor-readable instructions to cause the processor to schedule, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

Clause 89. The non-transitory, processor-readable storage medium of clause 77, wherein the processor-readable instructions to cause the processor to schedule transmission of the first signal comprise processor-readable instructions to cause the processor to schedule a long-term evolution positioning reference signal.

Clause 90. The non-transitory, processor-readable storage medium of clause 89, wherein the processor-readable instructions to cause the processor to schedule transmission of the first signal comprise processor-readable instructions to cause the processor to schedule the long-term evolution positioning reference signal instead of a new radio positioning reference signal.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment comprising:
a transceiver;
a memory; and
a processor, communicatively coupled to the memory and the transceiver, configured to:
receive, via the transceiver from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
receive, via the transceiver from the transmission/reception point, the first signal and the second signal; and
measure the first signal based on the quasi co-location indication indicating that the first signal is quasi co-located with the second signal.

2. The user equipment of claim 1, wherein the processor is configured to measure the first signal based further on a first periodicity of the first signal being shorter than a second periodicity of the second signal.

3. The user equipment of claim 2, wherein the processor is configured to wake up from an idle mode or an inactive mode to measure the first signal instead of the second signal based on the first periodicity of the first signal being shorter than the second periodicity of the second signal.

4. The user equipment of claim 1, wherein to measure the first signal the processor is configured to measure a receive power of the first signal, and wherein the processor is further configured to:
receive an indication of a first transmit power of the first signal; and
transmit, via the transceiver, an uplink positioning reference signal with a second transmit power based on the receive power of the first signal and the first transmit power of the first signal.

5. The user equipment of claim 1, wherein to measure the first signal the processor is configured to measure a time of arrival of the first signal in response to receiving, via the transceiver, a request to measure the time of arrival of the first signal.

6. The user equipment of claim 1, wherein the first signal occupies fewer than all subcarriers across a bandwidth of the first signal, and wherein the processor is further configured to:
receive indications of an expected reference signal time difference and an expected reference signal time difference uncertainty; and
select one of a plurality of candidate times of arrival, from measurement of the first signal, based on the expected reference signal time difference and the expected reference signal time difference uncertainty.

7. The user equipment of claim 1, wherein the second signal is a synchronization signal block, and wherein the processor is configured to measure the first signal based further on a downlink positioning reference signal of the transmission/reception point being quasi co-located with the synchronization signal block.

8. The user equipment of claim 1, wherein the first signal comprises a plurality of first signals each corresponding to a respective one of a plurality of antenna ports of the transmission/reception point, and wherein to measure the first signal the processor is configured to measure a plurality of times of arrival each corresponding to a respective one of the plurality of first signals, and wherein the processor is further configured to select, as an actual time of arrival, which of the plurality of times of arrival corresponds to a shortest travel time from the transmission/reception point to the user equipment.

9. The user equipment of claim 1, wherein the first signal is a first OFDM signal (first orthogonal frequency division multiplexing signal) and the second signal is a second OFDM signal.

10. A reference signal measurement method comprising:
receiving, at a user equipment from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
receiving, at the user equipment from the transmission/reception point, the first signal and the second signal; and
measuring, at the user equipment, the first signal based on the quasi co-location indication indicating that the first signal is quasi co-located with the second signal.

11. The reference signal measurement method of claim 10, wherein measuring the first signal is based further on a first periodicity of the first signal being shorter than a second periodicity of the second signal.

12. The reference signal measurement method of claim 11, wherein measuring the first signal comprises the user equipment waking up from an idle mode or an inactive mode to measure the first signal instead of the second signal based on the first periodicity of the first signal being shorter than the second periodicity of the second signal.

13. The reference signal measurement method of claim 10, wherein measuring the first signal comprises measuring a receive power of the first signal, and wherein the reference signal measurement method further comprises:
receiving, at the user equipment from the transmission/reception point, an indication of a first transmit power of the first signal; and
transmitting, from the user equipment to the transmission/reception point, an uplink positioning reference signal with a second transmit power based on the receive power of the first signal and the first transmit power of the first signal.

14. The reference signal measurement method of claim 10, wherein measuring the first signal comprises measuring a time of arrival of the first signal in response to receiving, at the user equipment, a request to measure the time of arrival of the first signal.

15. The reference signal measurement method of claim 10, wherein the first signal occupies fewer than all subcarriers across a bandwidth of the first signal, and wherein the reference signal measurement method further comprises:
receiving, at the user equipment, indications of an expected reference signal time difference and an expected reference signal time difference uncertainty; and
selecting one of a plurality of candidate times of arrival, from measurement of the first signal, based on the expected reference signal time difference and the expected reference signal time difference uncertainty.

16. The reference signal measurement method of claim 10, wherein the second signal is a synchronization signal block, and wherein measuring the first signal is based further on a downlink positioning reference signal of the transmission/reception point being quasi co-located with the synchronization signal block.

17. The reference signal measurement method of claim 10, wherein the first signal comprises a plurality of first signals each corresponding to a respective one of a plurality of antenna ports of the transmission/reception point, and wherein measuring the first signal comprises measuring a plurality of times of arrival each corresponding to a respective one of the plurality of first signals, and wherein the reference signal measurement method further comprises selecting, as an actual time of arrival, which of the plurality of times of arrival corresponds to a shortest travel time from the transmission/reception point to the user equipment.

18. The reference signal measurement method of claim 10, wherein the first signal is a first OFDM signal (first orthogonal frequency division multiplexing signal) and the second signal is a second OFDM signal.

19. A user equipment comprising:
means for receiving, from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
means for receiving, from the transmission/reception point, the first signal and the second signal; and
means for measuring the first signal based on the quasi co-location indication indicating that the first signal is quasi co-located with the second signal.

20. The user equipment of claim 19, wherein the means for measuring the first signal comprise means for measuring the first signal based further on a first periodicity of the first signal being shorter than a second periodicity of the second signal.

21. The user equipment of claim 20, wherein the means for measuring the first signal comprise means for waking up the user equipment from an idle mode or an inactive mode to measure the first signal instead of the second signal based on the first periodicity of the first signal being shorter than the second periodicity of the second signal.

22. The user equipment of claim 19, wherein the means for measuring the first signal comprise means for measuring a receive power of the first signal, and wherein the user equipment further comprises:
means for receiving, from the transmission/reception point, an indication of a first transmit power of the first signal; and
means for transmitting, to the transmission/reception point, an uplink positioning reference signal with a second transmit power based on the receive power of the first signal and the first transmit power of the first signal.

23. The user equipment of claim 19, wherein the means for measuring the first signal comprise means for measuring a time of arrival of the first signal in response to receiving, at the user equipment, a request to measure the time of arrival of the first signal.

24. The user equipment of claim 19, wherein the first signal occupies fewer than all subcarriers across a bandwidth of the first signal, and wherein the user equipment further comprises:
means for receiving indications of an expected reference signal time difference and an expected reference signal time difference uncertainty; and
means for selecting one of a plurality of candidate times of arrival, from measurement of the first signal, based on the expected reference signal time difference and the expected reference signal time difference uncertainty.

25. The user equipment of claim 9, wherein the second signal is a synchronization signal block, and wherein the means for measuring the first signal comprise means for measuring the first signal based further on a downlink positioning reference signal of the transmission/reception point being quasi co-located with the synchronization signal block.

26. The user equipment of claim 19, wherein the first signal comprises a plurality of first signals each corresponding to a respective one of a plurality of antenna ports of the transmission/reception point, and wherein the means for measuring the first signal comprise means for measuring a plurality of times of arrival each corresponding to a respective one of the plurality of first signals, and wherein the user equipment further comprises means for selecting, as an actual time of arrival, which of the plurality of times of arrival corresponds to a shortest travel time from the transmission/reception point to the user equipment.

27. A non-transitory, processor-readable storage medium comprising processor-readable instructions to cause a processor of a user equipment to:
receive, from a transmission/reception point, a quasi co-location indication that indicates that a first signal, from the transmission/reception point and corresponding to a first radio access technology, is quasi co-located with a second signal from the transmission/reception point and corresponding to a second radio access technology that is different from the first radio access technology;
receive, from the transmission/reception point, the first signal and the second signal; and
measure the first signal based on the quasi co-location indication indicating that the first signal is quasi co-located with the second signal.

28. The non-transitory, processor-readable storage medium of claim 27, wherein the processor-readable instructions to cause the processor to measure the first signal comprise processor-readable instructions to cause the processor to measure the first signal based further on a first periodicity of the first signal being shorter than a second periodicity of the second signal.

29. The non-transitory, processor-readable storage medium of claim 28, wherein the processor-readable instructions to cause the processor to measure the first signal comprise processor-readable instructions to cause the processor to wake up the user equipment from an idle mode or an inactive mode to measure the first signal instead of the second signal based on the first periodicity of the first signal being shorter than the second periodicity of the second signal.

30. The non-transitory, processor-readable storage medium of claim 27, wherein the processor-readable instructions to cause the processor to measure the first signal comprise processor-readable instructions to cause the processor to measure a receive power of the first signal, and wherein the non-transitory, processor-readable storage medium further comprises processor-readable instructions to cause the processor to:
receive, from the transmission/reception point, an indication of a first transmit power of the first signal; and
transmit, to the transmission/reception point, an uplink positioning reference signal with a second transmit power based on the receive power of the first signal and the first transmit power of the first signal.

31. The non-transitory, processor-readable storage medium of claim 27, wherein the processor-readable instructions to cause the processor to measure the first signal comprise processor-readable instructions to cause the processor to measure a time of arrival of the first signal in response to receiving, at the user equipment, a request to measure the time of arrival of the first signal.

32. The non-transitory, processor-readable storage medium of claim 27, wherein the first signal occupies fewer than all subcarriers across a bandwidth of the first signal, and wherein the non-transitory, processor-readable storage medium further comprises processor-readable instructions to cause the processor to:
receive indications of an expected reference signal time difference and an expected reference signal time difference uncertainty; and
select one of a plurality of candidate times of arrival, from measurement of the first signal, based on the expected reference signal time difference and the expected reference signal time difference uncertainty.

33. The non-transitory, processor-readable storage medium of claim 27, wherein the second signal is a synchronization signal block, and wherein the processor-readable instructions to cause the processor to measure the first signal comprise processor-readable instructions to cause the processor to measure the first signal based further on a downlink positioning reference signal of the transmission/reception point being quasi co-located with the synchronization signal block.

34. The non-transitory, processor-readable storage medium of claim 27, wherein the first signal comprises a plurality of first signals each corresponding to a respective one of a plurality of antenna ports of the transmission/reception point, and wherein the processor-readable instructions to cause the processor to measure the first signal comprise processor-readable instructions to cause the processor to measure a plurality of times of arrival each corresponding to a respective one of the plurality of first signals, and wherein the non-transitory, processor-readable storage medium further comprises processor-readable instructions to cause the processor to select, as an actual time of arrival, which of the plurality of times of arrival corresponds to a shortest travel time from the transmission/reception point to the user equipment.

35. A network entity comprising:
a transceiver;
a memory; and
a processor, communicatively coupled to the memory and the transceiver, configured to:
schedule transmission of a first signal, from a transmission/reception point and corresponding to a first radio access technology, and a second signal from the transmission/reception point and corresponding to a second radio access technology that is different from the first radio access technology; and
transmit, via the transceiver to a user equipment, a quasi co-location indication that indicates that the first signal is quasi co-located with the second signal.

36. The network entity of claim 35, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

37. The network entity of claim 36, wherein the processor is further configured to transmit, via the transceiver to the user equipment, a transmit power indication indicating a transmit power of the first OFDM signal by the transmission/reception point.

38. The network entity of claim 35, wherein to schedule transmission of the first signal, the processor is configured to schedule a channel reference signal based on the channel reference signal being quasi co-located with the second signal.

39. The network entity of claim 38, wherein the processor is further configured to transmit, via the transceiver to the user equipment, a pattern indication indicating a transmission pattern of the channel reference signal.

40. The network entity of claim 38, wherein the second signal is a positioning reference signal, and wherein to schedule transmission of the first signal and the second signal, the processor is configured to schedule transmission of the second signal in no symbol in which the first signal is scheduled for transmission.

41. The network entity of claim 35, wherein the first signal is a channel reference signal, and wherein the processor is further configured to transmit, via the transceiver to the user equipment, a request for the user equipment to measure the channel reference signal while the user equipment is in a radio resource control inactive mode or a radio resource control idle mode.

42. The network entity of claim 35, wherein the transmission/reception point is a first transmission/reception point, and wherein the processor is further configured to transmit, via the transceiver to the user equipment, an expected reference signal time difference between the first signal and a third signal corresponding to a second transmission/reception point that is separate from the first transmission/reception point.

43. The network entity of claim 35, wherein to schedule transmission of the first signal, the processor is configured to schedule a multi-antenna-port channel reference signal, and wherein the processor is further configured to transmit, via the transceiver to the user equipment, a request for the user equipment to report a measurement of the first signal for each antenna port of the multi-antenna-port channel reference signal.

44. The network entity of claim 35, wherein to schedule transmission of the first signal and the second signal, the processor is configured to schedule the first signal and the second signal with a shared spectrum.

45. The network entity of claim 44, wherein to schedule transmission of the first signal and the second signal, the processor is configured to schedule, for the user equipment in standalone mode, a downlink positioning reference signal in no symbols in which a channel reference signal or physical downlink control channel is scheduled in an MBSFN (multi-media broadcast over a single frequency network) subframe.

46. The network entity of claim 44, wherein to schedule transmission of the first signal and the second signal, the processor is configured to schedule, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

47. The network entity of claim 35, wherein to schedule transmission of the first signal, the processor is configured to schedule a long-term evolution positioning reference signal.

48. The network entity of claim 47, wherein to schedule transmission of the first signal, the processor is configured to schedule the long-term evolution positioning reference signal instead of a new radio positioning reference signal.

49. A signal transmission scheduling method comprising:
scheduling, by a network entity, transmission of a first signal, from a transmission/reception point and corresponding to a first radio access technology, and a second signal from the transmission/reception point and corresponding to a second radio access technology that is different from the first radio access technology; and
transmitting, from the network entity to a user equipment, a quasi co-location indication that indicates that the first signal is quasi co-located with the second signal.

50. The signal transmission scheduling method of claim 49, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

51. The signal transmission scheduling method of claim 50, further comprising transmitting, from the network entity to the user equipment, a transmit power indication indicating a transmit power of the first OFDM signal by the transmission/reception point.

52. The signal transmission scheduling method of claim 49, wherein scheduling transmission of the first signal comprises scheduling a channel reference signal based on the channel reference signal being quasi co-located with the second signal.

53. The signal transmission scheduling method of claim 52, further comprising transmitting, from the network entity to the user equipment, a pattern indication indicating an transmission pattern of the channel reference signal.

54. The signal transmission scheduling method of claim 52, wherein the second signal is a positioning reference signal, and wherein scheduling transmission of the first signal and the second signal comprises scheduling transmission of the second signal in no symbol in which the first signal is scheduled for transmission.

55. The signal transmission scheduling method of claim 49, wherein the first signal is a channel reference signal, and wherein the signal transmission scheduling method further comprises transmitting, from the network entity to the user equipment, a request for the user equipment to measure the channel reference signal while the user equipment is in a radio resource control inactive mode or a radio resource control idle mode.

56. The signal transmission scheduling method of claim 49, wherein the transmission/reception point is a first transmission/reception point, and wherein the signal transmission scheduling method further comprises transmitting, from the network entity to the user equipment, an expected reference signal time difference between the first signal and a third signal corresponding to a second transmission/reception point that is separate from the first transmission/reception point.

57. The signal transmission scheduling method of claim 49, wherein scheduling transmission of the first signal comprises scheduling a multi-antenna-port channel reference signal, and wherein the signal transmission scheduling method further comprises transmitting, from the network entity to the user equipment, a request for the user equipment to report a measurement of the first signal for each antenna port of the multi-antenna-port channel reference signal.

58. The signal transmission scheduling method of claim 49, wherein scheduling transmission of the first signal and the second signal comprises scheduling the first signal and the second signal with a shared spectrum.

59. The signal transmission scheduling method of claim 58, wherein scheduling transmission of the first signal and the second signal comprises scheduling, for the user equipment in standalone mode, a downlink positioning reference signal in no symbols in which a channel reference signal or physical downlink control channel is scheduled in an MBSFN (multi-media broadcast over a single frequency network) subframe.

60. The signal transmission scheduling method of claim 58, wherein scheduling transmission of the first signal and the second signal comprises scheduling, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

61. The signal transmission scheduling method of claim 49, wherein scheduling transmission of the first signal comprises scheduling a long-term evolution positioning reference signal.

62. The signal transmission scheduling method of claim 61, wherein scheduling transmission of the first signal comprises scheduling the long-term evolution positioning reference signal instead of a new radio positioning reference signal.

63. A network entity comprising:
means for scheduling transmission of a first signal, from a transmission/reception point and corresponding to a first radio access technology, and a second signal from the transmission/reception point and corresponding to a second radio access technology that is different from the first radio access technology; and
means for transmitting, to a user equipment, a quasi co-location indication that indicates that the first signal is quasi co-located with the second signal.

64. The network entity of claim 63, wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

65. The network entity of claim 64, further comprising means for transmitting, to the user equipment, a transmit power indication indicating a transmit power of the first OFDM signal by the transmission/reception point.

66. The network entity of claim 63, wherein the means for scheduling transmission of the first signal comprise means for scheduling a channel reference signal based on the channel reference signal being quasi co-located with the second signal.

67. The network entity of claim 66, further comprising means for transmitting, to the user equipment, a pattern indication indicating a transmission pattern of the channel reference signal.

68. The network entity of claim 66, wherein the second signal is a positioning reference signal, and wherein the means for scheduling transmission of the first signal and the second signal comprise means for scheduling transmission of the second signal in no symbol in which the first signal is scheduled for transmission.

69. The network entity of claim 63, wherein the first signal is a channel reference signal, and wherein the network entity further comprises means for transmitting, to the user equipment, a request for the user equipment to measure the channel reference signal while the user equipment is in a radio resource control inactive mode or a radio resource control idle mode.

70. The network entity of claim 63, wherein the transmission/reception point is a first transmission/reception point, and wherein the network entity further comprises means for transmitting, to the user equipment, an expected reference signal time difference between the first signal and a third signal corresponding to a second transmission/reception point that is separate from the first transmission/reception point.

71. The network entity of claim 63, wherein the means for scheduling transmission of the first signal comprise means for scheduling a multi-antenna-port channel reference signal, and wherein the network entity further comprises means for transmitting, to the user equipment, a request for the user equipment to report a measurement of the first signal for each antenna port of the multi-antenna-port channel reference signal.

72. The network entity of claim 63, wherein the means for scheduling transmission of the first signal and the second signal comprise means for scheduling the first signal and the second signal with a shared spectrum.

73. The network entity of claim 72, wherein the means for scheduling transmission of the first signal and the second signal comprise means for scheduling, for the user equipment in standalone mode, a downlink positioning reference signal in no symbols in which a channel reference signal or physical downlink control channel is scheduled in an MBSFN (multi-media broadcast over a single frequency network) subframe.

74. The network entity of claim 72, wherein the means for scheduling transmission of the first signal and the second signal comprise means for scheduling, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

75. The network entity of claim 63, wherein the means for scheduling transmission of the first signal comprise means for scheduling a long-term evolution positioning reference signal.

76. The network entity of claim 75, wherein the means for scheduling transmission of the first signal comprise means for scheduling the long-term evolution positioning reference signal instead of a new radio positioning reference signal.

77. A non-transitory, processor-readable storage medium comprising processor-readable instructions to cause a processor of a network entity to:
schedule transmission of a first signal, from a transmission/reception point and corresponding to a first radio access technology, and a second signal from the transmission/reception point and corresponding to a second radio access technology that is different from the first radio access technology; and
transmit, to a user equipment, a quasi co-location indication that indicates that the first signal is quasi co-located with the second signal.

78. The non-transitory, processor-readable storage medium of claim 77,
wherein the first signal is a first OFDM signal (first orthogonal frequency division multiplexing signal) that is a long-term evolution channel reference signal or a long-term evolution positioning reference signal, and wherein the second signal is a second OFDM signal that is a new radio positioning reference signal or a new radio synchronization signal block.

79. The non-transitory, processor-readable storage medium of claim 78, further comprising processor-readable instructions to cause the processor to transmit, to the user equipment, a transmit power indication indicating a transmit power of the first OFDM signal by the transmission/reception point.

80. The non-transitory, processor-readable storage medium of claim 77, wherein the processor-readable instructions to cause the processor to schedule transmission of the first signal comprise processor-readable instructions to cause the processor to schedule a channel reference signal based on the channel reference signal being quasi co-located with the second signal.

81. The non-transitory, processor-readable storage medium of claim 80, further comprising processor-readable instructions to cause the processor to transmit, to the user equipment, a pattern indication indicating an transmission pattern of the channel reference signal.

82. The non-transitory, processor-readable storage medium of claim 80, wherein the second signal is a positioning reference signal, and wherein the processor-readable instructions to cause the processor to schedule transmission of the first signal and the second signal comprise processor-readable instructions to cause the processor to schedule transmission of the second signal in no symbol in which the first signal is scheduled for transmission.

83. The non-transitory, processor-readable storage medium of claim 77, wherein the first signal is a channel reference signal, and wherein the non-transitory, processor-readable storage medium further comprises processor-readable instructions to cause the processor to transmit, to the user equipment, a request for the user equipment to measure the channel reference signal while the user equipment is in a radio resource control inactive mode or a radio resource control idle mode.

84. The non-transitory, processor-readable storage medium of claim 77, wherein the transmission/reception point is a first transmission/reception point, and wherein the non-transitory, processor-readable storage medium further comprises processor-readable instructions to cause the processor to transmit, to the user equipment, an expected reference signal time difference between the first signal and a third signal corresponding to a second transmission/reception point that is separate from the first transmission/reception point.

85. The non-transitory, processor-readable storage medium of claim 77, wherein the processor-readable instructions to cause the processor to schedule transmission of the first signal comprise processor-readable instructions to cause the processor to schedule a multi-antenna-port channel reference signal, and wherein the non-transitory, processor-readable storage medium further comprises processor-readable instructions to cause the processor to transmit, to the user equipment, a request for the user equipment to report a measurement of the first signal for each antenna port of the multi-antenna-port channel reference signal.

86. The non-transitory, processor-readable storage medium of claim 77, wherein the processor-readable instructions to cause the processor to schedule transmission of the first signal and the second signal comprise processor-readable instructions to cause the processor to schedule the first signal and the second signal with a shared spectrum.

87. The non-transitory, processor-readable storage medium of claim 86, wherein the processor-readable instructions to cause the processor to schedule transmission of the first signal and the second signal comprise processor-readable instructions to cause the processor to schedule, for the user equipment in standalone mode, a downlink positioning reference signal in no symbols in which a channel reference signal or physical downlink control channel is scheduled in an MBSFN (multi-media broadcast over a single frequency network) subframe.

88. The non-transitory, processor-readable storage medium of claim 86, wherein the processor-readable instructions to cause the processor to schedule transmission of the first signal and the second signal comprise processor-readable instructions to cause the processor to schedule, for the user equipment in standalone mode, a downlink positioning reference signal in no symbols in which a channel reference signal, a physical downlink control channel, a physical hybrid automatic repeat request indicator channel, or physical control format indicator channel is scheduled in a non-MBSFN (non-multi-media broadcast over a single frequency network) subframe.

89. The non-transitory, processor-readable storage medium of claim 77, wherein the processor-readable instructions to cause the processor to schedule transmission of the first signal comprise processor-readable instructions to cause the processor to schedule a long-term evolution positioning reference signal.

90. The non-transitory, processor-readable storage medium of claim 89, wherein the processor-readable instructions to cause the processor to schedule transmission of the first signal comprise processor-readable instructions to cause the processor to schedule the long-term evolution positioning reference signal instead of a new radio positioning reference signal.
